(19) United States
(12) Patent Application Publication
(10) Pub. No.: US 2023/0402219 A1
(43) Pub. Date: Dec. 14, 2023

(54) AN INDUCTOR COIL

(71) Applicant: ETA GREEN POWER LTD., Hethel, Norfolk (GB)

(72) Inventor: Liam Bowman, Old Catton, Norfolk (GB)

(21) Appl. No.: 18/033,698

(22) PCT Filed: Oct. 27, 2021
(86) PCT No.: PCT/EP2021/079753

§ 371 Date: Apr. 25, 2023

(30) Foreign Application Priority Data
Oct. 28, 2020 (EP) 20204342.8

(51) Int. Cl. H01F 27/08; H01F 27/06

(52) U.S. Cl. CPC H01F 27/08; H01F 27/06; H01F 2027/065

(57) ABSTRACT

The present invention relates to an inductor coil, comprising: a first component (12); a second component (14); and a length of conductor (18); wherein, the first component is located adjacent to the second component; wherein, a core (16) is formed from the first component and the second component; wherein the core is located along a first portion of a central axis and a second portion of the central axis; wherein, along a third portion of the central axis the first component is spaced from the second component to form a gap (20, 30) in the core, wherein the third portion of the central axis is between the first portion of the central axis and the second portion of the central axis; wherein, a first part of the length of conductor is located around the first portion of the central axis, located around the second portion of the central axis, and located around the third portion of the central axis to form a plurality of turns of conductor around the core and the gap in the core; and wherein, at least one section of the first part of the length of conductor is compressed in the direction of the central axis.

### FIELD OF THE INVENTION

The present invention relates to inductor coils and methods of forming or manufacturing inductor coils.

### BACKGROUND OF THE INVENTION

State of the inductor coils use flat helical wound copper or ribbon shaped windings for high current applications. This leads to low values of direct current resistance (DCR). This has great benefits, but a significant disadvantage relating to AC losses within the flat wound element of the coil.

To achieve low a DCR, a thicker flat copper foil >2 mm is used. This however amplifies any high frequency (HF) AC losses within the coil by anywhere from 5-20 times the normal DC losses.

There is another problematic effect that is associated with coils with such high power density, and this is due to the large gap in the core of the coil that is required to achieve desirable maximum saturation currents. Larger magnetic gaps result in larger fringing fields, and any permeable material placed close to the magnetic gap will incur eddy losses. This in turn causes areas of significant temperature rises with both stranded and flat ribbon wound coils. Some existing methods try to solve this issue by using bobbin shapes to avoid temperature hot spots, but this results in a reduction in cross sectional area that would could otherwise be utilised for copper, and also reduces the thermal performance of the coil. Other methods use a distributed gap in the core to reduce the fringing field, but this adds significant cost to the manufacturing costs.

There is a need to address these issues.

### SUMMARY OF THE INVENTION

It would be advantageous to have improved inductor coil.

The object of the present invention is solved with the subject matter of the independent claims, wherein further embodiments are incorporated in the dependent claims. It should be noted that the following described aspects and examples of the invention apply also to the inductor coils and to the methods of forming inductor coils.

In a first aspect, there is provided an inductor coil, comprising:
a first component;
a second component; and
a length of conductor.

The first component is located adjacent to the second component. A core is formed from the first component and the second component. The core is located along a first portion of a central axis and a second portion of the central axis. Along a third portion of the central axis the first component is spaced from the second component to form a gap in the core. The third portion of the central axis is between the first portion of the central axis and the second portion of the central axis. A first part of the length of conductor is located around the first portion of the central axis, located around the second portion of the central axis, and located around the third portion of the central axis to form a plurality of turns of conductor around the core and the gap in the core. At least one section of the first part of the length of conductor is compressed in the direction of the central axis.

In this manner, the coil with a compressed conductor can achieve lower or equal DCR than existing coils, but at the same time the AC losses rather than being 5-20 times the DC losses now only 1-3 times the DC losses.

In an example, a second part and a third part of the length of conductor at the ends of the length of conductor form part of connection terminals of the inductor coil.

In an example, the whole of the first part of the length of the conductor is compressed.

In an example, the at least one section of the first part of the length of conductor that is compressed has a dimension of the conductor in the direction of the central axis that is less than a dimension of the conductor in a direction perpendicular to the central axis.

In an example, at least one section of the first part of the length of conductor between a base portion of the first component and a base portion of the second component is compressed between and by the base portion of the first component and the base portion of the second component.

By compressing the conductor during assembly of the inductor coil mitigates putting tension in the wire for wire that has already been fully compressed, and that is then would around the core. The wire can however be partially compressed prior to being wound around and/or located around the core, and then further compressed as the first and second components are brought together and further compressing the conductor.

In an example, the whole of the first part of the length of conductor can be compressed prior to being located around the core and gap in the core. In an example, the first and second base portions can have base portions that only extend laterally over a certain angular range. Then the first part of the length of the conductor can be located around the core and gap in the core, and then the base portions of the first and second parts are moved toward each other and then the length of the conductor over these angular ranges can then be further compressed by the base portions.

In an example, the first part of the length of the conductor can be located around the core and the gap in the core, and then the base portions of the first and second parts are moved toward each other and only the conductor at the angular positions where the base portions face one another is compressed.

In an example, the first part of the length of conductor is at least partially compressed prior to being located around the first portion of the central axis, located around the second portion of the central axis, and located around the third portion of the central axis.

In an example, adjacent turns of the plurality of turns of conductor are bonded to each other.

This for example, facilitates prior compression of the first part of the length of conductor before it is located around the core gap in the core of the inductor coil, parts of the conductor turns may not then be under compression between the base portions of the first component and second component, but remain in a compressed tight arrangement.

In an example, each turn of conductor of the plurality of turns of conductor has an inner part of the conductor spaced at least one distance from the central axis in a direction perpendicular to the central axis. The inner part of the conductor of two or more turns of the conductor located around the first portion of the central axis and/or located around the second portion of the central axis is/are spaced from the central axis by at least one first distance. The inner part of the conductor of one or more turns of the conductor located around the third portion of the central axis is spaced from the central axis by at least one second distance greater than the at least one first distance.

In other words, the turns of the conductor at the position of the gap in the core are spaced further from axis of the inductor coil than the other turns around the core. This can be through either displacement of the turns sideways, or deformation of the inner part of the conductor turns facing the axis of the inductor coil. In this manner, the inductor coil does not lead to induced eddy currents that would otherwise be caused by conductive material being present in these fringing fields. This avoids temperature hotspots, maximises the available cross-sectional area of conductor, and maximises the thermal performance of the coil.

In an example, a spacer is located in the gap in the core to form a gap around the core. An outer surface of a portion of the spacer is located a distance from the central axis that is greater than a distance from the central axis of an outer surface of the first component and an outer surface of the second component that form the core.

In other words, the spacer is positioned in the gap in the core, and is wider than the diameter of the core, and when the first part of the length of conductor is located around the core and gap in the core, the spacer forms a space around the outer extent of the gap in the core, by either in effect pushing conductor turns sideways, and/or deforming the inner part of each conductor turn at the location of the gap in the core.

In an example, a dimension of the portion of the spacer adjacent to the outer surface of the first component and the outer surface of the second component in the direction of the central axis is greater than a dimension of the gap in the core in the direction of the central axis.

In an example, the outer surface of the portion of the spacer is configured to contact the one or more turns of conductor located around the third portion of the central axis.

In an example, the spacer comprises a non-conductive material.

In an example, the spacer comprises a central hole configured to be located around the central axis.

In an example, the first component comprises a ferrite material.

In an example, the second component comprises a ferrite material.

In an example, the conductor comprises a multi-strand wire.

In an example, the conductor comprises a Litz wire.

In a second aspect, there is provided an inductor coil, comprising:
a first component;
a second component; and
a length of conductor.

The first component is located adjacent to the second component. A core is formed from the second component. The core is located along a first portion of a central axis. Along a second portion of the central axis the first component is spaced from the second component to form a gap in the core. The second portion of the central axis is between the first portion of the central axis and the first component. A first part of the length of conductor is located around the first portion of the central axis, and located around the second portion of the central axis to form a plurality of turns of conductor around the core and the gap in the core. At least one section of the first part of the length of conductor is compressed in the direction of the central axis.

In this manner, compressed coil can achieve lower or equal DCR than existing coils, but at the same time the AC losses rather than being 5-20 times the DC losses now only 1-3 times the DC losses.

In an example, a second part and a third part of the length of conductor at the ends of the length of conductor form part of connection terminals of the inductor coil.

In an example, the whole of the first part of the length of the conductor is compressed.

In an example, the at least one section of the first part of the length of conductor that is compressed has a dimension of the conductor in the direction of the central axis that is less than a dimension of the conductor in a direction perpendicular to the central axis.

In an example, at least one section of the first part of the length of conductor between a base portion of the first component and a base portion of the second component is compressed between and by the base portion of the first component and the base portion of the second component.

By compressing the conductor during assembly of the inductor coil mitigates putting tension in the wire for wire that has already been fully compressed, and that is then would around the core. The wire can however be partially compressed prior to being wound around and/or located around the core, and then further compressed as the first and second components are brought together and further compressing the conductor.

In an example, the whole of the first part of the length of conductor can be compressed prior to being located around the core and gap in the core. In an example the first and second base portions can have base portions that only extend laterally over a certain angular range. Then the first part of the length of the conductor can be located around the core and gap in the core, and then the base portions of the first and second parts are moved toward each other and then the length of the conductor over these angular ranges can then be further compressed by the base portions.

In, and example the first part of the length of the conductor can be located around the core and the gap in the core, and then the base portions of the first and second parts are moved toward each other and only the conductor at the angular positions where the base portions face one another is compressed.

In an example, the first part of the length of conductor is at least partially compressed prior to being located around the first portion of the central axis, and located around the second portion of the central axis.

In an example, adjacent turns of the plurality of turns of conductor are bonded to each other.

This for example, facilitates prior compression of the first part of the length of conductor before it is located around the core gap in the core of the inductor coil, parts of the conductor turns may not then be under compression between the base portions of the first component and second component, but remain in a compressed tight arrangement.

In an example, each turn of conductor of the plurality of turns of conductor has an inner part of the conductor spaced at least one distance from the central axis in a direction perpendicular to the central axis, wherein the inner part of the conductor of two or more turns of the conductor located around the first portion of the central axis is spaced from the central axis by at least one first distance, and wherein the inner part of the conductor of one or more turns of the conductor located around the second portion of the central axis is spaced from the central axis by at least one second distance greater than the at least one first distance.

In other words, the turns of the conductor at the position of the gap in the core are spaced further from axis of the inductor coil than the other turns around the core. This can be through either displacement of the turns sideways, or deformation of the inner part of the conductor turns facing the axis of the inductor coil. In this manner, the inductor coil does not lead to induced eddy currents that would otherwise be caused by conductive material being present in these fringing fields. This avoids temperature hotspots, maximises the available cross-sectional area of conductor, and maximises the thermal performance of the coil.

In an example, a spacer is located in the gap in the core to form a gap around the core. An outer surface of a portion of the spacer is located a distance from the central axis that is greater than a distance from the central axis of an outer surface of the second component that forms the core.

In other words, the spacer is positioned in the gap in the core, and is wider than the diameter of the core, and when the first part of the length of conductor is located around the core and gap in the core, the spacer forms a space around the outer extent of the gap in the core, by either in effect pushing conductor turns sideways, and/or deforming the inner part of each conductor turn at the location of the gap in the core.

In an example, a dimension of the portion of the spacer adjacent to the outer surface of the second component in the direction of the central axis is greater than a dimension of the gap in the core in the direction of the central axis.

In an example, the outer surface of the portion of the spacer is configured to contact the one or more turns of conductor located around the second portion of the central axis.

In an example, the spacer comprises a non-conductive material.

In an example, the spacer comprises a central hole configured to be located around the central axis.

In an example, the first component comprises a ferrite material.

In an example, the second component comprises a ferrite material.

In an example, the conductor comprises a multi-strand wire.

In an example, the conductor comprises a Litz wire.

In a third aspect, there is provided an inductor coil, comprising:
a first component;
a second component; and
a length of conductor.

The first component is located adjacent to the second component. A core is formed from the first component and the second component. The core is located along a first portion of a central axis and a second portion of the central axis. Along a third portion of the central axis the first component is spaced from the second component to form a gap in the core. The third portion of the central axis is between the first portion of the central axis and the second portion of the central axis. A first part of the length of conductor is located around the first portion of the central axis, located around the second portion of the central axis, and located around the third portion of the central axis to form a plurality of turns of conductor around the core and the gap in the core. Each turn of conductor of the plurality of turns of conductor has an inner part of the conductor spaced at least one distance from the central axis in a direction perpendicular to the central axis. The inner part of the conductor of two or more turns of the conductor located around the first portion of the central axis and/or located around the second portion of the central axis is/are spaced from the central axis by at least one first distance. The inner part of the conductor of one or more turns of the conductor located around the third portion of the central axis is spaced from the central axis by at least one second distance greater than the at least one first distance.

In other words, the turns of the conductor at the position of the gap in the core are spaced further from axis of the inductor coil than the other turns around the core. This can be through either displacement of the turns sideways, or deformation of the inner part of the conductor turns facing the axis of the inductor coil. In this manner, the inductor coil does not lead to induced eddy currents that would otherwise be caused by conductive material being present in these fringing fields. This avoids temperature hotspots, maximises the available cross-sectional area of conductor, and maximises the thermal performance of the coil.

In an example, a second part and a third part of the length of conductor at the ends of the length of conductor form part of connection terminals of the inductor coil.

In an example, the whole of the first part of the length of the conductor is compressed.

In an example, a spacer is located in the gap in the core to form a gap around the core. An outer surface of a portion of the spacer is located a distance from the central axis that is greater than a distance from the central axis of an outer surface of the first component and an outer surface of the second component that form the core.

In other words, the spacer is positioned in the gap in the core, and is wider than the diameter of the core, and when the first part of the length of conductor is located around the core and gap in the core, the spacer forms a space around the outer extent of the gap in the core, by either in effect pushing conductor turns sideways, and/or deforming the inner part of each conductor turn at the location of the gap in the core.

In an example, a dimension of the portion of the spacer adjacent to the outer surface of the first component and the outer surface of the second component in the direction of the central axis is greater than a dimension of the gap in the core in the direction of the central axis.

In an example, the outer surface of the portion of the spacer is configured to contact the one or more turns of conductor located around the third portion of the central axis.

In an example, the spacer comprises a non-conductive material.

In an example, the spacer comprises a central hole configured to be located around the central axis.

In an example, at least one section of the first part of the length of conductor is compressed in the direction of the central axis.

In this manner, compressed coil can achieve lower or equal DCR than existing coils, but at the same time the AC losses rather than being 5-20 times the DC losses now only 1-3 times the DC losses.

In an example, the at least one section of the first part of the length of conductor that is compressed has a dimension of the conductor in the direction of the central axis that is less than a dimension of the conductor in a direction perpendicular to the central axis.

In an example, at least one section of the first part of the length of conductor between a base portion of the first component and a base portion of the second component is compressed between and by the base portion of the first component and the base portion of the second component.

By compressing the conductor during assembly of the inductor coil mitigates putting tension in the wire for wire that has already been fully compressed, and that is then would around the core. The wire can however be partially compressed prior to being wound around and/or located around the core, and then further compressed as the first and second components are brought together and further compressing the conductor.

In an example, the whole of the first part of the length of conductor can be compressed prior to being located around the core and gap in the core. In an example the first and second base portions can have base portions that only extend laterally over a certain angular range. Then the first part of the length of the conductor can be located around the core and gap in the core, and then the base portions of the first and second parts are moved toward each other and then the length of the conductor over these angular ranges can then be further compressed by the base portions.

In an example the first part of the length of the conductor can be located around the core and the gap in the core, and then the base portions of the first and second parts are moved toward each other and only the conductor at the angular positions where the base portions face one another is compressed.

In an example, the first part of the length of conductor is at least partially compressed prior to being located around the first portion of the central axis, located around the second portion of the central axis, and located around the third portion of the central axis.

Inductor coil according to any of claims 31-40, wherein adjacent turns of the plurality of turns of conductor are bonded to each other.

This for example, facilitates prior compression of the first part of the length of conductor before it is located around the core gap in the core of the inductor coil, parts of the conductor turns may not then be under compression between the base portions of the first component and second component, but remain in a compressed tight arrangement.

In a fourth aspect, there is provided an inductor coil, comprising:
a first component;
a second component; and
a length of conductor (18).

The first component is located adjacent to the second component. A core is formed from the second component. The core is located along a first portion of a central axis. Along a second portion of the central axis the first component is spaced from the second component to form a gap in the core. The second portion of the central axis is between the first portion of the central axis and the first component. A first part of the length of conductor is located around the first portion of the central axis, and located around the second portion of the central axis to form a plurality of turns of conductor around the core and the gap in the core. Each turn of conductor of the plurality of turns of conductor has an inner part of the conductor spaced at least one distance from the central axis in a direction perpendicular to the central axis. The inner part of the conductor of two or more turns of the conductor located around the first portion of the central axis is spaced from the central axis by at least one first distance. The inner part of the conductor of one or more turns of the conductor located around the second portion of the central axis is spaced from the central axis by at least one second distance greater than the at least one first distance.

In other words, the turns of the conductor at the position of the gap in the core are spaced further from axis of the inductor coil than the other turns around the core. This can be through either displacement of the turns sideways, or deformation of the inner part of the conductor turns facing the axis of the inductor coil. In this manner, the inductor coil does not lead to induced eddy currents that would otherwise be caused by conductive material being present in these fringing fields. This avoids temperature hotspots, maximises the available cross-sectional area of conductor, and maximises the thermal performance of the coil.

In an example, a second part and a third part of the length of conductor at the ends of the length of conductor form part of connection terminals of the inductor coil.

In an example, the whole of the first part of the length of the conductor is compressed.

In an example, a spacer is located in the gap in the core to form a gap around the core. An outer surface of a portion of the spacer is located a distance from the central axis that is greater than a distance from the central axis of an outer surface of the second component that forms the core.

In other words, the spacer is positioned in the gap in the core, and is wider than the diameter of the core, and when the first part of the length of conductor is located around the core and gap in the core, the spacer forms a space around the outer extent of the gap in the core, by either in effect pushing conductor turns sideways, and/or deforming the inner part of each conductor turn at the location of the gap in the core.

In an example, a dimension of the portion of the spacer adjacent to the outer surface of the second component in the direction of the central axis is greater than a dimension of the gap in the core in the direction of the central axis.

In an example, the outer surface of the portion of the spacer is configured to contact the one or more turns of conductor located around the second portion of the central axis.

In an example, the spacer comprises a non-conductive material.

In an example, the spacer comprises a central hole configured to be located around the central axis.

In an example, at least one section of the first part of the length of conductor is compressed in the direction of the central axis.

In this manner, compressed coil can achieve lower or equal DCR than existing coils, but at the same time the AC losses rather than being 5-20 times the DC losses now only 1-3 times the DC losses.

In an example, the at least one section of the first part of the length of conductor that is compressed has a dimension of the conductor in the direction of the central axis that is less than a dimension of the conductor in a direction perpendicular to the central axis.

In an example, at least one section of the first part of the length of conductor between a base portion of the first component and a base portion of the second component is compressed between and by the base portion of the first component and the base portion of the second component.

By compressing the conductor during assembly of the inductor coil mitigates putting tension in the wire for wire that has already been fully compressed, and that is then would around the core. The wire can however be partially compressed prior to being wound around and/or located around the core, and then further compressed as the first and second components are brought together and further compressing the conductor.

In an example, the whole of the first part of the length of conductor can be compressed prior to being located around the core and gap in the core. In an example the first and second base portions can have base portions that only extend laterally over a certain angular range. Then the first part of the length of the conductor can be located around the core and gap in the core, and then the base portions of the first and second parts are moved toward each other and then the length of the conductor over these angular ranges can then be further compressed by the base portions.

In, and example the first part of the length of the conductor can be located around the core and the gap in the core, and then the base portions of the first and second parts are moved toward each other and only the conductor at the angular positions where the base portions face one another is compressed.

In an example, the first part of the length of conductor is at least partially compressed prior to being located around the first portion of the central axis, and located around the second portion of the central axis.

In an example, adjacent turns of the plurality of turns of conductor are bonded to each other.

This for example, facilitates prior compression of the first part of the length of conductor before it is located around the core gap in the core of the inductor coil, parts of the conductor turns may not then be under compression between the base portions of the first component and second component, but remain in a compressed tight arrangement.

In an example, the first component comprises a ferrite material.

In an example, the second component comprises a ferrite material.

In an example, the conductor comprises a multi-strand wire.

In an example, the conductor comprises a Litz wire.

In a fifth aspect, there is provided a method of forming an inductor coil, comprising:
locating a first component adjacent to a second component, wherein, a core is formed from the first component and the second component, wherein the core is located along a first portion of a central axis and a second portion of the central axis, and wherein along a third portion of the central axis the first component is spaced from the second component to form a gap in the core, wherein the third portion of the central axis is between the first portion of the central axis and the second portion of the central axis;
locating a first part of a length of conductor around the first portion of the central axis, around the second portion of the central axis, and around the third portion of the central axis to form a plurality of turns of conductor around the core and the gap in the core; and
compressing in the direction of the central axis at least one section of the first part of the length of conductor.

In this manner, compressed coil can achieve lower or equal DCR than existing coils, but at the same time the AC losses rather than being 5-20 times the DC losses now only 1-3 times the DC losses.

In an example, a second part and a third part of the length of conductor at the ends of the length of conductor form part of connection terminals of the inductor coil.

In an example, the whole of the first part of the length of the conductor is compressed.

In an example, the at least one section of the first part of the length of conductor that is compressed has a dimension of the conductor in the direction of the central axis that is less than a dimension of the conductor in a direction perpendicular to the central axis.

In an example, the method comprises compressing at least one section of the first part of the length of conductor between a base portion of the first component and a base portion of the second component.

By compressing the conductor during assembly of the inductor coil mitigates putting tension in the wire for wire that has already been fully compressed, and that is then would around the core. The wire can however be partially compressed prior to being wound around and/or located around the core, and then further compressed as the first and second components are brought together and further compressing the conductor.

In an example, the whole of the first part of the length of conductor can be compressed prior to being located around the core and gap in the core. In an example the first and second base portions can have base portions that only extend laterally over a certain angular range. Then the first part of the length of the conductor can be located around the core and gap in the core, and then the base portions of the first and second parts are moved toward each other and then the length of the conductor over these angular ranges can then be further compressed by the base portions.

In, and example the first part of the length of the conductor can be located around the core and the gap in the core, and then the base portions of the first and second parts are moved toward each other and only the conductor at the angular positions where the base portions face one another is compressed.

In an example, the method comprises at least partially compressing the first part of the length of conductor prior to locating it around the first portion of the central axis, around the second portion of the central axis, and around the third portion of the central axis.

In an example, the method comprises bonding adjacent turns of the plurality of turns of conductor to each other.

This for example, facilitates prior compression of the first part of the length of conductor before it is located around the core gap in the core of the inductor coil, parts of the conductor turns may not then be under compression between the base portions of the first component and second component, but remain in a compressed tight arrangement.

In an example, the method comprises locating the length of conductor such that each turn of conductor of the plurality of turns of conductor has an inner part of the conductor spaced at least one distance from the central axis in a direction perpendicular to the central axis. The inner part of the conductor of two or more turns of the conductor located around the first portion of the central axis and/or located around the second portion of the central axis is/are spaced from the central axis by at least one first distance. The inner part of the conductor of one or more turns of the conductor located around the third portion of the central axis is spaced from the central axis by at least one second distance greater than the at least one first distance.

In other words, the turns of the conductor at the position of the gap in the core are spaced further from axis of the inductor coil than the other turns around the core. This can be through either displacement of the turns sideways, or deformation of the inner part of the conductor turns facing the axis of the inductor coil. In this manner, the inductor coil does not lead to induced eddy currents that would otherwise be caused by conductive material being present in these fringing fields. This avoids temperature hotspots, maximises the available cross-sectional area of conductor, and maximises the thermal performance of the coil.

In an example, the method comprises locating a spacer in the gap in the core to form a gap around the core. An outer surface of a portion of the spacer is located a distance from the central axis that is greater than a distance from the central axis of an outer surface of the first component and an outer surface of the second component that form the core.

In other words, the spacer is positioned in the gap in the core, and is wider than the diameter of the core, and when the first part of the length of conductor is located around the core and gap in the core, the spacer forms a space around the outer extent of the gap in the core, by either in effect pushing conductor turns sideways, and/or deforming the inner part of each conductor turn at the location of the gap in the core.

In an example, a dimension of the portion of the spacer adjacent to the outer surface of the first component and the outer surface of the second component in the direction of the central axis is greater than a dimension of the gap in the core in the direction of the central axis.

In an example, the method comprises contacting the outer surface of the portion of the spacer with the one or more turns of conductor located around the third portion of the central axis.

In an example, the spacer comprises a non-conductive material.

In an example, the spacer comprises a central hole configured to be located around the central axis.

In an example, the first component comprises a ferrite material.

In an example, the second component comprises a ferrite material.

In an example, the conductor comprises a multi-strand wire.

In an example, the conductor comprises a Litz wire.

In a sixth aspect, there is provided a method of forming an inductor coil, comprising:
locating a first component adjacent to a second component, wherein a core is formed from the second component, wherein the core is located along a first portion of a central axis, wherein along a second portion of the central axis the first component is spaced from the second component to form a gap in the core, and wherein the second portion of the central axis is between the first portion of the central axis and the first component;
locating a first part of a length of conductor around the first portion of the central axis, and around the second portion of the central axis to form a plurality of turns of conductor around the core and the gap in the core; and
compressing in the direction of the central axis at least one section of the first part of the length of conductor.

In this manner, compressed coil can achieve lower or equal DCR than existing coils, but at the same time the AC losses rather than being 5-20 times the DC losses now only 1-3 times the DC losses.

In an example, a second part and a third part of the length of conductor at the ends of the length of conductor form part of connection terminals of the inductor coil.

In an example, the whole of the first part of the length of the conductor is compressed.

In an example, the at least one of the first part of the length of conductor that is compressed has a dimension of the conductor in the direction of the central axis that is less than a dimension of the conductor in a direction perpendicular to the central axis.

In an example, method comprises compressing at least one section of the first part of the length of conductor between a base portion of the first component and a base portion of the second component.

By compressing the conductor during assembly of the inductor coil mitigates putting tension in the wire for wire that has already been fully compressed, and that is then would around the core. The wire can however be partially compressed prior to being wound around and/or located around the core, and then further compressed as the first and second components are brought together and further compressing the conductor.

In an example, the whole of the first part of the length of conductor can be compressed prior to being located around the core and gap in the core. In an example the first and second base portions can have base portions that only extend laterally over a certain angular range. Then the first part of the length of the conductor can be located around the core and gap in the core, and then the base portions of the first and second parts are moved toward each other and then the length of the conductor over these angular ranges can then be further compressed by the base portions.

In an example, the first part of the length of the conductor can be located around the core and the gap in the core, and then the base portions of the first and second parts are moved toward each other and only the conductor at the angular positions where the base portions face one another is compressed.

In an example, the method comprises at least partially compressing the first part of the length of conductor prior to locating it around the first portion of the central axis, and around the second portion of the central axis.

In an example, the method comprises bonding adjacent turns of the plurality of turns of conductor to each other.

This for example, facilitates prior compression of the first part of the length of conductor before it is located around the core gap in the core of the inductor coil, parts of the conductor turns may not then be under compression between the base portions of the first component and second component, but remain in a compressed tight arrangement.

In an example, the method comprises locating the length of conductor such that each turn of conductor of the plurality of turns of conductor has an inner part of the conductor spaced at least one distance from the central axis in a direction perpendicular to the central axis. The inner part of the conductor of two or more turns of the conductor located around the first portion of the central axis is spaced from the central axis by at least one first distance. The inner part of the conductor of one or more turns of the conductor located around the second portion of the central axis is spaced from the central axis by at least one second distance greater than the at least one first distance.

In other words, the turns of the conductor at the position of the gap in the core are spaced further from axis of the inductor coil than the other turns around the core. This can be through either displacement of the turns sideways, or deformation of the inner part of the conductor turns facing the axis of the inductor coil. In this manner, the inductor coil does not lead to induced eddy currents that would otherwise be caused by conductive material being present in these fringing fields. This avoids temperature hotspots, maximises the available cross-sectional area of conductor, and maximises the thermal performance of the coil.

In an example, the method comprises locating a spacer in the gap in the core to form a gap around the core. An outer surface of a portion of the spacer is located a distance from the central axis that is greater than a distance from the central axis of an outer surface of the second component that forms the core.

In other words, the spacer is positioned in the gap in the core, and is wider than the diameter of the core, and when the first part of the length of conductor is located around the core and gap in the core, the spacer forms a space around the outer extent of the gap in the core, by either in effect pushing conductor turns sideways, and/or deforming the inner part of each conductor turn at the location of the gap in the core.

In an example, a dimension of the portion of the spacer adjacent to the outer surface of the second component in the direction of the central axis is greater than a dimension of the gap in the core in the direction of the central axis.

In an example, the method comprises contacting the outer surface of the portion of the spacer with the one or more turns of conductor located around the second portion of the central axis.

In an example, the spacer comprises a non-conductive material.

In an example, the spacer comprises a central hole configured to be located around the central axis.

In an example, the first component comprises a ferrite material.

In an example, the second component comprises a ferrite material.

In an example, the conductor comprises a multi-strand wire.

In an example, the conductor comprises a Litz wire.

In a seventh aspect, there is provided a method of forming an inductor coil, comprising:
locating a first component adjacent to the second component, wherein a core is formed from the first component and the second component, wherein the core is located along a first portion of a central axis and a second portion of the central axis, wherein along a third portion of the central axis the first component is spaced from the second component to form a gap in the core, and wherein the third portion of the central axis is between the first portion of the central axis and the second portion of the central axis;
locating a first part of the length of conductor around the first portion of the central axis, around the second portion of the central axis, and around the third portion of the central axis to form a plurality of turns of conductor around the core and the gap in the core; and
locating the first part of the length of conductor such that each turn of conductor of the plurality of turns of conductor has an inner part of the conductor spaced at least one distance from the central axis in a direction perpendicular to the central axis. The inner part of the conductor of two or more turns of the conductor located around the first portion of the central axis and/or located around the second portion of the central axis is/are spaced from the central axis by at least one first distance. The inner part of the conductor of one or more turns of the conductor located around the third portion of the central axis is spaced from the central axis by at least one second distance greater than the at least one first distance.

In other words, the turns of the conductor at the position of the gap in the core are spaced further from axis of the inductor coil than the other turns around the core. This can be through either displacement of the turns sideways, or deformation of the inner part of the conductor turns facing the axis of the inductor coil. In this manner, the inductor coil does not lead to induced eddy currents that would otherwise be caused by conductive material being present in these fringing fields. This avoids temperature hotspots, maximises the available cross-sectional area of conductor, and maximises the thermal performance of the coil.

In an example, a second part and a third part of the length of conductor at the ends of the length of conductor form part of connection terminals of the inductor coil.

In an example, the whole of the first part of the length of the conductor is compressed.

In an example, the method comprises locating a spacer in the gap in the core to form a gap around the core. An outer surface of a portion of the spacer is located a distance from the central axis that is greater than a distance from the central axis of an outer surface of the first component and an outer surface of the second component that form the core.

In other words, the spacer is positioned in the gap in the core, and is wider than the diameter of the core, and when the first part of the length of conductor is located around the core and gap in the core, the spacer forms a space around the outer extent of the gap in the core, by either in effect pushing conductor turns sideways, and/or deforming the inner part of each conductor turn at the location of the gap in the core.

In an example, a dimension of the portion of the spacer adjacent to the outer surface of the first component and the outer surface of the second component in the direction of the central axis is greater than a dimension of the gap in the core in the direction of the central axis.

In an example, the method comprises contacting the outer surface of the portion of the spacer with the one or more turns of conductor located around the third portion of the central axis.

In an example, the spacer comprises a non-conductive material.

In an example, the spacer comprises a central hole configured to be located around the central axis.

In an example, the method comprises compressing at least one section of the first part of the length of conductor in the direction of the central axis.

In this manner, compressed coil can achieve lower or equal DCR than existing coils, but at the same time the AC losses rather than being 5-20 times the DC losses now only 1-3 times the DC losses.

In an example, the at least one of the first part of the length of conductor that is compressed has a dimension of the conductor in the direction of the central axis that is less than a dimension of the conductor in a direction perpendicular to the central axis.

In an example, the method comprises compressing at least one section of the first part of the length of conductor between a base portion of the first component and a base portion of the second component.

By compressing the conductor during assembly of the inductor coil mitigates putting tension in the wire for wire that has already been fully compressed, and that is then would around the core. The wire can however be partially compressed prior to being wound around and/or located around the core, and then further compressed as the first and second components are brought together and further compressing the conductor.

In an example, the whole of the first part of the length of conductor can be compressed prior to being located around the core and gap in the core. In an example the first and second base portions can have base portions that only extend laterally over a certain angular range. Then the first part of the length of the conductor can be located around the core and gap in the core, and then the base portions of the first and second parts are moved toward each other and then the length of the conductor over these angular ranges can then be further compressed by the base portions.

In, and example the first part of the length of the conductor can be located around the core and the gap in the core, and then the base portions of the first and second parts are moved toward each other and only the conductor at the angular positions where the base portions face one another is compressed.

In an example, the method comprises at least partially compressing the first part of the length of conductor prior to locating it around the first portion of the central axis, around the second portion of the central axis, and around the third portion of the central axis.

In an example, adjacent turns of the plurality of turns of conductor are bonded to each other.

This for example, facilitates prior compression of the first part of the length of conductor before it is located around the core gap in the core of the inductor coil, parts of the conductor turns may not then be under compression between the base portions of the first component and second component, but remain in a compressed tight arrangement.

In an eighth aspect, there is provided a method of forming an inductor coil, comprising:
locating a first component adjacent to a second component, wherein a core is formed from the second component, wherein the core is located along a first portion of a central axis, wherein along a second portion of the central axis the first component is spaced from the second component to form a gap in the core, and wherein the second portion of the central axis is between the first portion of the central axis and the first component;
locating a first part of a length of conductor around the first portion of the central axis, and around the second portion of the central axis to form a plurality of turns of conductor around the core and the gap in the core; and
locating the first part of the length of conductor such that each turn of conductor of the plurality of turns of conductor has an inner part of the conductor spaced at least one distance from the central axis in a direction perpendicular to the central axis. The inner part of the conductor of two or more turns of the conductor located around the first portion of the central axis is spaced from the central axis by at least one first distance. The inner part of the conductor of one or more turns of the conductor located around the second portion of the central axis is spaced from the central axis by at least one second distance greater than the at least one first distance.

In other words, the turns of the conductor at the position of the gap in the core are spaced further from axis of the inductor coil than the other turns around the core. This can be through either displacement of the turns sideways, or deformation of the inner part of the conductor turns facing the axis of the inductor coil. In this manner, the inductor coil does not lead to induced eddy currents that would otherwise be caused by conductive material being present in these fringing fields. This avoids temperature hotspots, maximises the available cross-sectional area of conductor, and maximises the thermal performance of the coil.

In an example, a second part and a third part of the length of conductor at the ends of the length of conductor form part of connection terminals of the inductor coil.

In an example, the whole of the first part of the length of the conductor is compressed.

In an example, the method comprises locating a spacer in the gap in the core to form a gap around the core. An outer surface of a portion of the spacer is located a distance from the central axis that is greater than a distance from the central axis of an outer surface of the second component that forms the core.

In other words, the spacer is positioned in the gap in the core, and is wider than the diameter of the core, and when the first part of the length of conductor is located around the core and gap in the core, the spacer forms a space around the outer extent of the gap in the core, by either in effect pushing conductor turns sideways, and/or deforming the inner part of each conductor turn at the location of the gap in the core.

In an example, a dimension of the portion of the spacer adjacent to the outer surface of the second component in the direction of the central axis is greater than a dimension of the gap in the core in the direction of the central axis.

In an example, the method comprises contacting the outer surface of the portion of the spacer with the one or more turns of conductor located around the second portion of the central axis.

In an example, the spacer comprises a non-conductive material.

In an example, the spacer comprises a central hole configured to be located around the central axis.

In an example, the method comprises compressing at least one section of the first part of the length of conductor in the direction of the central axis.

In this manner, compressed coil can achieve lower or equal DCR than existing coils, but at the same time the AC losses rather than being 5-20 times the DC losses now only 1-3 times the DC losses.

In an example, the at least one section of the first part of the length of conductor that is compressed has a dimension of the conductor in the direction of the central axis that is less than a dimension of the conductor in a direction perpendicular to the central axis.

In an example, the method comprises compressing at least one section of the first part of the length of conductor between a base portion of the first component and a base portion of the second component.

By compressing the conductor during assembly of the inductor coil mitigates putting tension in the wire for wire that has already been fully compressed, and that is then would around the core. The wire can however be partially compressed prior to being wound around and/or located around the core, and then further compressed as the first and second components are brought together and further compressing the conductor.

In an example, the whole of the first part of the length of conductor can be compressed prior to being located around the core and gap in the core. In an example the first and second base portions can have base portions that only extend laterally over a certain angular range. Then the first part of the length of the conductor can be located around the core and gap in the core, and then the base portions of the first and second parts are moved toward each other and then the length of the conductor over these angular ranges can then be further compressed by the base portions.

In an example, the first part of the length of the conductor can be located around the core and the gap in the core, and then the base portions of the first and second parts are moved toward each other and only the conductor at the angular positions where the base portions face one another is compressed.

In an example, the method comprises at least partially compressing the first part of the length of conductor prior to locating it around the first portion of the central axis, and around the second portion of the central axis.

In an example, the method comprises bonding adjacent turns of the plurality of turns of conductor to each other.

This for example, facilitates prior compression of the first part of the length of conductor before it is located around the core gap in the core of the inductor coil, parts of the conductor turns may not then be under compression between the base portions of the first component and second component, but remain in a compressed tight arrangement.

In an example, the first component comprises a ferrite material.

In an example, the second component comprises a ferrite material.

In an example, the conductor comprises a multi-strand wire.

In an example, the conductor comprises a Litz wire.

Advantageously, the benefits provided by any of the above aspects equally apply to all of the other aspects and vice versa.

The above aspects and examples will become apparent from and be elucidated with reference to the embodiments described hereinafter.

### BRIEF DESCRIPTION OF THE DRAWINGS

Exemplary embodiments will be described in the following with reference to the following drawings:

FIG. 1 shows a schematic set up of a vertical cross through an example of an inductor coil;

FIG. 2 shows a schematic set up of a vertical cross through an example of an inductor coil;

FIG. 3 shows a schematic set up of an example of a vertical cross through wire turns of an inductor coil;

FIG. 4 shows a schematic set up of a vertical cross through an example of an inductor coil;

FIG. 5 shows a schematic set up of an example of component parts of an inductor coil without the conductor;

FIG. 6 shows a schematic set up of a horizontal cross section through an exemplar inductor coil;

FIG. 7 shows a schematic set up of a vertical cross through an example of the conductor and spacer of an inductor coil;

FIG. 8 shows a schematic set up of an example of a vertical cross through an inductor coil with separated parts;

FIG. 9 shows a schematic set up of an example of a vertical cross through an inductor coil and a horizontal cross section through the inductor coil;

FIG. 10 shows a schematic set up of a vertical cross through an part of example of an inductor coil showing a conductor formed from a multi-strand wire with a representation showing deformation of the multi-stand wires of the conductor;

FIG. 11 shows a schematic set up of an example of a vertical cross through an inductor coil and a horizontal cross section through the inductor coil;

FIG. 12 shows a schematic set up of an example of a vertical cross through an inductor coil; and

FIG. 13 shows a schematic set up of an example of a vertical cross through an inductor coil.

### DETAILED DESCRIPTION OF EMBODIMENTS

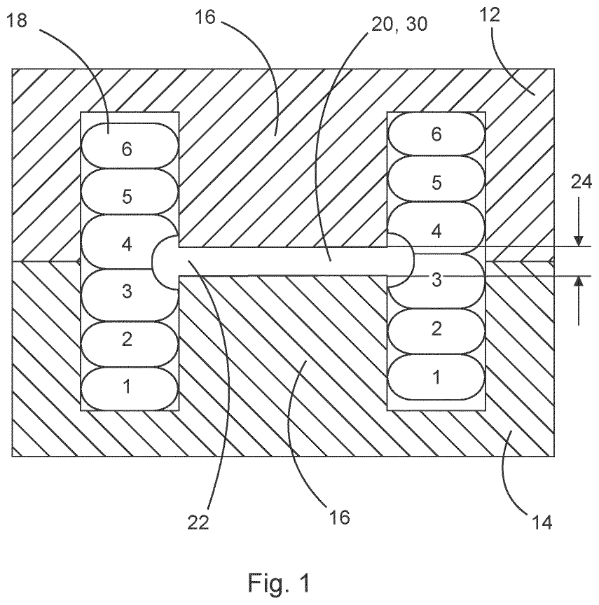

FIGS. 1-13 relate to inductor coils and methods of forming or manufacturing inductor coils.

In an example an inductor coil comprises a first component 12, a second component 14, and a length of conductor 18. The first component is located adjacent to the second component. A core 16 is formed from the first component and the second component. The core is located along a first portion of a central axis and a second portion of the central axis. Along a third portion of the central axis the first component is spaced from the second component to form a gap 20, 30 in the core. The third portion of the central axis is between the first portion of the central axis and the second portion of the central axis. A first part of the length of conductor is located around the first portion of the central axis, located around the second portion of the central axis, and located around the third portion of the central axis to form a plurality of turns of conductor around the core and the gap in the core. At least one section of the first part of the length of conductor is compressed in the direction of the central axis.

In an example, a second part and a third part of the length of conductor at the ends of the length of conductor form part of connection terminals of the inductor coil.

In an example, the whole of the first part of the length of the conductor is compressed.

In an example, the at least one section of the first part of the length of conductor that is compressed has a dimension of the conductor in the direction of the central axis that is less than a dimension of the conductor in a direction perpendicular to the central axis.

In an example, at least one section of the first part of the length of conductor between a base portion of the first component and a base portion of the second component is compressed between and by the base portion of the first component and the base portion of the second component.

In an example, the whole of the first part of the length of conductor can be compressed prior to being located around the core and gap in the core. In an example the first and second base portions can have base portions that only extend laterally over a certain angular range. Then the first part of the length of the conductor can be located around the core and gap in the core, and then the base portions of the first and second parts are moved toward each other and then the length of the conductor over these angular ranges can then be further compressed by the base portions.

In an example, the first part of the length of the conductor can be located around the core and the gap in the core, and then the base portions of the first and second parts are moved toward each other and only the conductor at the angular positions where the base portions face one another is compressed.

In an example, the first part of the length of conductor is at least partially compressed prior to being located around the first portion of the central axis, located around the second portion of the central axis, and located around the third portion of the central axis.

In an example, adjacent turns of the plurality of turns of conductor are bonded to each other.

In an example, each turn of conductor of the plurality of turns of conductor has an inner part of the conductor spaced at least one distance from the central axis in a direction perpendicular to the central axis. The inner part of the conductor of two or more turns of the conductor located around the first portion of the central axis and/or located around the second portion of the central axis is/are spaced from the central axis by at least one first distance. The inner part of the conductor of one or more turns of the conductor located around the third portion of the central axis is spaced from the central axis by at least one second distance greater than the at least one first distance.

In an example, a spacer 30 is located in the gap in the core to form a gap 22 around the core. An outer surface of a portion of the spacer is located a distance from the central axis that is greater than a distance from the central axis of an outer surface of the first component and an outer surface of the second component that form the core.

In an example, a dimension of the portion of the spacer adjacent to the outer surface of the first component and the outer surface of the second component in the direction of the central axis is greater than a dimension of the gap 24 in the core in the direction of the central axis.

In an example, the outer surface of the portion of the spacer is configured to contact the one or more turns of conductor located around the third portion of the central axis.

In an example, the spacer comprises a non-conductive material.

In an example, the spacer comprises a central hole 32 configured to be located around the central axis.

In an example, the first component comprises a ferrite material.

In an example, the second component comprises a ferrite material.

In an example, the conductor comprises a multi-strand wire.

In an example, the conductor comprises a Litz wire.

In an example an inductor coil comprises a first component 12, a second component 14, and a length of conductor 18. The first component is located adjacent to the second component. A core 16 is formed from the second component. The core is located along a first portion of a central axis. Along a second portion of the central axis the first component is spaced from the second component to form a gap 40, 50 in the core. The second portion of the central axis is between the first portion of the central axis and the first component. A first part of the length of conductor is located around the first portion of the central axis, and located around the second portion of the central axis to form a plurality of turns of conductor around the core and the gap in the core. At least one section of the first part of the length of conductor is compressed in the direction of the central axis.

In an example, a second part and a third part of the length of conductor at the ends of the length of conductor form part of connection terminals of the inductor coil.

In an example, the whole of the first part of the length of the conductor is compressed.

In an example, the at least one section of the first part of the length of conductor that is compressed has a dimension of the conductor in the direction of the central axis that is less than a dimension of the conductor in a direction perpendicular to the central axis.

In an example, at least one section of the first part of the length of conductor between a base portion of the first component and a base portion of the second component is compressed between and by the base portion of the first component and the base portion of the second component.

In an example, the whole of the first part of the length of conductor can be compressed prior to being located around the core and gap in the core. In an example the first and second base portions can have base portions that only extend laterally over a certain angular range. Then the first part of the length of the conductor can be located around the core and gap in the core, and then the base portions of the first and second parts are moved toward each other and then the length of the conductor over these angular ranges can then be further compressed by the base portions.

In an example, the first part of the length of the conductor can be located around the core and the gap in the core, and then the base portions of the first and second parts are moved toward each other and only the conductor at the angular positions where the base portions face one another is compressed.

In an example, the first part of the length of conductor is at least partially compressed prior to being located around the first portion of the central axis, and located around the second portion of the central axis.

In an example, adjacent turns of the plurality of turns of conductor are bonded to each other.

In an example, each turn of conductor of the plurality of turns of conductor has an inner part of the conductor spaced at least one distance from the central axis in a direction perpendicular to the central axis. The inner part of the conductor of two or more turns of the conductor located around the first portion of the central axis is/are spaced from the central axis by at least one first distance. The inner part of the conductor of one or more turns of the conductor located around the second portion of the central axis is spaced from the central axis by at least one second distance greater than the at least one first distance.

In an example, a spacer 50 is located in the gap in the core to form a gap 42 around the core. An outer surface of a portion of the spacer is located a distance from the central axis that is greater than a distance from the central axis of an outer surface of the second component that forms the core.

In an example, a dimension of the portion of the spacer adjacent to the outer surface of the second component in the direction of the central axis is greater than a dimension of the gap 24 in the core in the direction of the central axis.

In an example, the outer surface of the portion of the spacer is configured to contact the one or more turns of conductor located around the second portion of the central axis.

In an example, the spacer comprises a non-conductive material.

In an example, the spacer comprises a central hole configured to be located around the central axis.

In an example, the first component comprises a ferrite material.

In an example, the second component comprises a ferrite material.

In an example, the conductor comprises a multi-strand wire.

In an example, the conductor comprises a Litz wire.

In an example an inductor coil comprises a first component 12, a second component 14, and a length of conductor 18. The first component is located adjacent to the second component. A core 16 is formed from the first component and the second component. The core is located along a first portion of a central axis and a second portion of the central axis. Along a third portion of the central axis the first component is spaced from the second component to form a gap 20, 30 in the core. The third portion of the central axis is between the first portion of the central axis and the second portion of the central axis. A first part of the length of conductor is located around the first portion of the central axis, located around the second portion of the central axis, and located around the third portion of the central axis to form a plurality of turns of conductor around the core and the gap in the core. Each turn of conductor of the plurality of turns of conductor has an inner part of the conductor spaced at least one distance from the central axis in a direction perpendicular to the central axis. The inner part of the conductor of two or more turns of the conductor located around the first portion of the central axis and/or located around the second portion of the central axis is/are spaced from the central axis by at least one first distance. The inner part of the conductor of one or more turns of the conductor located around the third portion of the central axis is spaced from the central axis by at least one second distance greater than the at least one first distance.

In an example, a second part and a third part of the length of conductor at the ends of the length of conductor form part of connection terminals of the inductor coil.

In an example, the whole of the first part of the length of the conductor is compressed.

In an example, a spacer 30 is located in the gap in the core to form a gap 22 around the core. An outer surface of a portion of the spacer is located a distance from the central axis that is greater than a distance from the central axis of an outer surface of the first component and an outer surface of the second component that form the core.

In an example, a dimension of the portion of the spacer adjacent to the outer surface of the first component and the outer surface of the second component in the direction of the central axis is greater than a dimension of the gap 24 in the core in the direction of the central axis.

In an example, the outer surface of the portion of the spacer is configured to contact the one or more turns of conductor located around the third portion of the central axis.

In an example, the spacer comprises a non-conductive material.

In an example, the spacer comprises a central hole 32 configured to be located around the central axis.

In an example, at least one section of the first part of the length of conductor is compressed in the direction of the central axis.

In an example, the at least one section of the first part of the length of conductor that is compressed has a dimension of the conductor in the direction of the central axis that is less than a dimension of the conductor in a direction perpendicular to the central axis.

In an example, at least one section of the first part of the length of conductor between a base portion of the first component and a base portion of the second component is compressed between and by the base portion of the first component and the base portion of the second component.

In an example, the whole of the first part of the length of conductor can be compressed prior to being located around the core and gap in the core. In an example the first and second base portions can have base portions that only extend laterally over a certain angular range. Then the first part of the length of the conductor can be located around the core and gap in the core, and then the base portions of the first and second parts are moved toward each other and then the length of the conductor over these angular ranges can then be further compressed by the base portions.

In an example, the first part of the length of the conductor can be located around the core and the gap in the core, and then the base portions of the first and second parts are moved toward each other and only the conductor at the angular positions where the base portions face one another is compressed.

In an example, the first part of the length of conductor is at least partially compressed prior to being located around the first portion of the central axis, located around the second portion of the central axis, and located around the third portion of the central axis.

In an example, adjacent turns of the plurality of turns of conductor are bonded to each other.

In an example, an inductor coil comprises a first component 12, a second component 14, and a length of conductor 18. The first component is located adjacent to the second component. A core 16 is formed from the second component. The core is located along a first portion of a central axis. Along a second portion of the central axis the first component is spaced from the second component to form a gap 40, 50 in the core. The second portion of the central axis is between the first portion of the central axis and the first component. A first part of the length of conductor is located around the first portion of the central axis, and located around the second portion of the central axis to form a plurality of turns of conductor around the core and the gap in the core. Each turn of conductor of the plurality of turns of conductor has an inner part of the conductor spaced at least one distance from the central axis in a direction perpendicular to the central axis. The inner part of the conductor of two or more turns of the conductor located around the first portion of the central axis is spaced from the central axis by at least one first distance. The inner part of the conductor of one or more turns of the conductor located around the second portion of the central axis is spaced from the central axis by at least one second distance greater than the at least one first distance.

In an example, a second part and a third part of the length of conductor at the ends of the length of conductor form part of connection terminals of the inductor coil.

In an example, the whole of the first part of the length of the conductor is compressed.

In an example, a spacer 50 is located in the gap in the core to form a gap 42 around the core. An outer surface of a portion of the spacer is located a distance from the central axis that is greater than a distance from the central axis of an outer surface of the second component that forms the core.

In an example, a dimension of the portion of the spacer adjacent to the outer surface of the second component in the direction of the central axis is greater than a dimension of the gap 24 in the core in the direction of the central axis.

In an example, the outer surface of the portion of the spacer is configured to contact the one or more turns of conductor located around the second portion of the central axis.

In an example, the spacer comprises a non-conductive material.

In an example, the spacer comprises a central hole configured to be located around the central axis.

In an example, at least one section of the first part of the length of conductor is compressed in the direction of the central axis.

In an example, the at least one section of the first part of the length of conductor that is compressed has a dimension of the conductor in the direction of the central axis that is less than a dimension of the conductor in a direction perpendicular to the central axis.

In an example, at least one section of the first part of the length of conductor between a base portion of the first component and a base portion of the second component is compressed between and by the base portion of the first component and the base portion of the second component.

In an example, the whole of the first part of the length of conductor can be compressed prior to being located around the core and gap in the core. In an example the first and second base portions can have base portions that only extend laterally over a certain angular range. Then the first part of the length of the conductor can be located around the core and gap in the core, and then the base portions of the first and second parts are moved toward each other and then the length of the conductor over these angular ranges can then be further compressed by the base portions.

In an example, the first part of the length of the conductor can be located around the core and the gap in the core, and then the base portions of the first and second parts are moved toward each other and only the conductor at the angular positions where the base portions face one another is compressed.

In an example, the first part of the length of conductor is at least partially compressed prior to being located around the first portion of the central axis, and located around the second portion of the central axis.

In an example, adjacent turns of the plurality of turns of conductor are bonded to each other.

In an example, the first component comprises a ferrite material.

In an example, the second component comprises a ferrite material.

In an example, the conductor comprises a multi-strand wire.

In an example, the conductor comprises a Litz wire.

In an example, a method of forming an inductor coil comprises:
locating a first component 12 adjacent to a second component 14. A core 16 is formed from the first component and the second component. The core is located along a first portion of a central axis and a second portion of the central axis. Along a third portion of the central axis the first component is spaced from the second component to form a gap 20, 30 in the core. The third portion of the central axis is between the first portion of the central axis and the second portion of the central axis;
locating a first part of a length of conductor 18 around the first portion of the central axis, around the second portion of the central axis, and around the third portion of the central axis to form a plurality of turns of conductor around the core and the gap in the core; and
compressing in the direction of the central axis at least one section of the first part of the length of conductor.
   It is to be noted, that the method steps can be carried out in different orders and certain steps can be carried out contemporaneously, and certain steps can be carried out more than once—for example the compressing step.

In an example, a second part and a third part of the length of conductor at the ends of the length of conductor form part of connection terminals of the inductor coil.

In an example, the whole of the first part of the length of the conductor is compressed.

In an example, the at least one section of the first part of the length of conductor that is compressed has a dimension of the conductor in the direction of the central axis that is less than a dimension of the conductor in a direction perpendicular to the central axis.

In an example, the method comprises compressing at least one section of the first part of the length of conductor between a base portion of the first component and a base portion of the second component.

In an example, the whole of the first part of the length of conductor can be compressed prior to being located around the core and gap in the core. In an example the first and second base portions can have base portions that only extend laterally over a certain angular range. Then the first part of the length of the conductor can be located around the core and gap in the core, and then the base portions of the first and second parts are moved toward each other and then the length of the conductor over these angular ranges can then be further compressed by the base portions.

In an example the first part of the length of the conductor can be located around the core and the gap in the core, and then the base portions of the first and second parts are moved toward each other and only the conductor at the angular positions where the base portions face one another is compressed.

In an example, the method comprises at least partially compressing the first part of the length of conductor prior to locating it around the first portion of the central axis, around the second portion of the central axis, and around the third portion of the central axis.

In an example, the method comprises bonding adjacent turns of the plurality of turns of conductor to each other.

In an example, method comprises locating the length of conductor such that each turn of conductor of the plurality of turns of conductor has an inner part of the conductor spaced at least one distance from the central axis in a direction perpendicular to the central axis. The inner part of the conductor of two or more turns of the conductor located around the first portion of the central axis and/or located around the second portion of the central axis is/are spaced from the central axis by at least one first distance. The inner part of the conductor of one or more turns of the conductor located around the third portion of the central axis is spaced from the central axis by at least one second distance greater than the at least one first distance.

In an example, the method comprises locating a spacer 30 in the gap in the core to form a gap 22 around the core. An outer surface of a portion of the spacer is located a distance from the central axis that is greater than a distance from the central axis of an outer surface of the first component and an outer surface of the second component that form the core.

In an example, a dimension of the portion of the spacer adjacent to the outer surface of the first component and the outer surface of the second component in the direction of the central axis is greater than a dimension of the gap 24 in the core in the direction of the central axis.

In an example, the method comprises contacting the outer surface of the portion of the spacer with the one or more turns of conductor located around the third portion of the central axis.

In an example, the spacer comprises a non-conductive material.

In an example, the spacer comprises a central hole 32 configured to be located around the central axis.

In an example, the first component comprises a ferrite material.

In an example, the second component comprises a ferrite material.

In an example, the conductor comprises a multi-strand wire.

In an example, the conductor comprises a Litz wire.

In an example, a method of forming an inductor coil comprises
locating a first component 12 adjacent to a second component 14. A core is formed from the second component. The core is located along a first portion of a central axis. Along a second portion of the central axis the first component is spaced from the second component to form a gap 40, 50 in the core. The second portion of the central axis is between the first portion of the central axis and the first component;
locating a first part of a length of conductor (18) around the first portion of the central axis, and around the second portion of the central axis to form a plurality of turns of conductor around the core and the gap in the core; and
compressing in the direction of the central axis at least one section of the first part of the length of conductor.

It is to be noted, that the method steps can be carried out in different orders and certain steps can be carried out contemporaneously, and certain steps can be carried out more than once—for example the compressing step.

In an example, a second part and a third part of the length of conductor at the ends of the length of conductor form part of connection terminals of the inductor coil.

In an example, the whole of the first part of the length of the conductor is compressed.

In an example, the at least one of the first part of the length of conductor that is compressed has a dimension of the conductor in the direction of the central axis that is less than a dimension of the conductor in a direction perpendicular to the central axis.

In an example, method comprises compressing at least one section of the first part of the length of conductor between a base portion of the first component and a base portion of the second component.

In an example, the whole of the first part of the length of conductor can be compressed prior to being located around the core and gap in the core. In an example the first and second base portions can have base portions that only extend laterally over a certain angular range. Then the first part of the length of the conductor can be located around the core and gap in the core, and then the base portions of the first and second parts are moved toward each other and then the length of the conductor over these angular ranges can then be further compressed by the base portions.

In an example the first part of the length of the conductor can be located around the core and the gap in the core, and then the base portions of the first and second parts are moved toward each other and only the conductor at the angular positions where the base portions face one another is compressed.

In an example, the method comprises at least partially compressing the first part of the length of conductor prior to locating it around the first portion of the central axis, and around the second portion of the central axis.

In an example, the method comprises bonding adjacent turns of the plurality of turns of conductor to each other.

In an example, the method comprises locating the length of conductor such that each turn of conductor of the plurality of turns of conductor has an inner part of the conductor spaced at least one distance from the central axis in a direction perpendicular to the central axis. The inner part of the conductor of two or more turns of the conductor located around the first portion of the central axis is spaced from the central axis by at least one first distance. The inner part of the conductor of one or more turns of the conductor located around the second portion of the central axis is spaced from the central axis by at least one second distance greater than the at least one first distance.

In an example, the method comprises locating a spacer 50 in the gap in the core to form a gap 42 around the core. An outer surface of a portion of the spacer is located a distance from the central axis that is greater than a distance from the central axis of an outer surface of the second component that forms the core.

In an example, a dimension of the portion of the spacer adjacent to the outer surface of the second component in the direction of the central axis is greater than a dimension of the gap 24 in the core in the direction of the central axis.

In an example, the method comprises contacting the outer surface of the portion of the spacer with the one or more turns of conductor located around the second portion of the central axis.

In an example, the spacer comprises a non-conductive material.

In an example, the spacer comprises a central hole configured to be located around the central axis.

In an example, the first component comprises a ferrite material.

In an example, the second component comprises a ferrite material.

In an example, the conductor comprises a multi-strand wire.

In an example, the conductor comprises a Litz wire.

In an example, a method of forming an inductor coil comprises:
locating a first component 12 adjacent to the second component 14. A core 16 is formed from the first component and the second component. The core is located along a first portion of a central axis and a second portion of the central axis. Along a third portion of the central axis the first component is spaced from the second component to form a gap 20, 30 in the core. The third portion of the central axis is between the first portion of the central axis and the second portion of the central axis,
locating a first part of the length of conductor 18 around the first portion of the central axis, around the second portion of the central axis, and around the third portion of the central axis to form a plurality of turns of conductor around the core and the gap in the core; and
locating the first part of the length of conductor such that each turn of conductor of the plurality of turns of conductor has an inner part of the conductor spaced at least one distance from the central axis in a direction perpendicular to the central axis. The inner part of the conductor of two or more turns of the conductor located around the first portion of the central axis and/or located around the second portion of the central axis is/are spaced from the central axis by at least one first distance. The inner part of the conductor of one or more turns of the conductor located around the third portion of the central axis is spaced from the central axis by at least one second distance greater than the at least one first distance.

It is to be noted, that the method steps can be carried out in different orders and certain steps can be carried out contemporaneously.

In an example, a second part and a third part of the length of conductor at the ends of the length of conductor form part of connection terminals of the inductor coil.

In an example, the whole of the first part of the length of the conductor is compressed.

In an example, the method comprises locating a spacer 30 in the gap in the core to form a gap 22 around the core. An outer surface of a portion of the spacer is located a distance from the central axis that is greater than a distance from the central axis of an outer surface of the first component and an outer surface of the second component that form the core.

In an example, a dimension of the portion of the spacer adjacent to the outer surface of the first component and the outer surface of the second component in the direction of the central axis is greater than a dimension of the gap 24 in the core in the direction of the central axis.

In an example, the method comprises contacting the outer surface of the portion of the spacer with the one or more turns of conductor located around the third portion of the central axis.

In an example, the spacer comprises a non-conductive material.

In an example, the spacer comprises a central hole 32 configured to be located around the central axis.

In an example, the method comprises compressing at least one section of the first part of the length of conductor in the direction of the central axis.

In an example, the at least one of the first part of the length of conductor that is compressed has a dimension of the conductor in the direction of the central axis that is less than a dimension of the conductor in a direction perpendicular to the central axis.

In an example, the method comprises compressing at least one section of the first part of the length of conductor between a base portion of the first component and a base portion of the second component.

In an example, the whole of the first part of the length of conductor can be compressed prior to being located around the core and gap in the core. In an example the first and second base portions can have base portions that only extend laterally over a certain angular range. Then the first part of the length of the conductor can be located around the core and gap in the core, and then the base portions of the first and second parts are moved toward each other and then the length of the conductor over these angular ranges can then be further compressed by the base portions.

In an example, the first part of the length of the conductor can be located around the core and the gap in the core, and then the base portions of the first and second parts are moved toward each other and only the conductor at the angular positions where the base portions face one another is compressed.

In an example, the method comprises at least partially compressing the first part of the length of conductor prior to locating it around the first portion of the central axis, around the second portion of the central axis, and around the third portion of the central axis.

In an example, adjacent turns of the plurality of turns of conductor are bonded to each other.

In an example, a method of forming an inductor coil comprises:
locating a first component 12 adjacent to a second component 14. A core 16 is formed from the second component. The core is located along a first portion of a central axis. Along a second portion of the central axis the first component is spaced from the second component to form a gap 40, 50 in the core. The second portion of the central axis is between the first portion of the central axis and the first component;
locating a first part of a length of conductor 18 around the first portion of the central axis, and around the second portion of the central axis to form a plurality of turns of conductor around the core and the gap in the core; and
locating the first part of the length of conductor such that each turn of conductor of the plurality of turns of conductor has an inner part of the conductor spaced at least one distance from the central axis in a direction perpendicular to the central axis. The inner part of the conductor of two or more turns of the conductor located around the first portion of the central axis is spaced from the central axis by at least one first distance. The inner part of the conductor of one or more turns of the conductor located around the second portion of the central axis is spaced from the central axis by at least one second distance greater than the at least one first distance.

In an example, a second part and a third part of the length of conductor at the ends of the length of conductor form part of connection terminals of the inductor coil.

In an example, the whole of the first part of the length of the conductor is compressed.

In an example, the method comprises locating a spacer 50 in the gap in the core to form a gap 42 around the core. An outer surface of a portion of the spacer is located a distance from the central axis that is greater than a distance from the central axis of an outer surface of the second component that forms the core.

In an example, a dimension of the portion of the spacer adjacent to the outer surface of the second component in the direction of the central axis is greater than a dimension of the gap 24 in the core in the direction of the central axis.

In an example, the method comprises contacting the outer surface of the portion of the spacer with the one or more turns of conductor located around the second portion of the central axis.

In an example, the spacer comprises a non-conductive material.

In an example, the spacer comprises a central hole configured to be located around the central axis.

In an example, the method comprises compressing at least one section of the first part of the length of conductor in the direction of the central axis.

In an example, the at least one section of the first part of the length of conductor that is compressed has a dimension of the conductor in the direction of the central axis that is less than a dimension of the conductor in a direction perpendicular to the central axis.

In an example, the method comprises compressing at least one section of the first part of the length of conductor between a base portion of the first component and a base portion of the second component.

In an example, the whole of the first part of the length of conductor can be compressed prior to being located around the core and gap in the core. In an example the first and second base portions can have base portions that only extend laterally over a certain angular range. Then the first part of the length of the conductor can be located around the core and gap in the core, and then the base portions of the first and second parts are moved toward each other and then the length of the conductor over these angular ranges can then be further compressed by the base portions.

In an example the first part of the length of the conductor can be located around the core and the gap in the core, and then the base portions of the first and second parts are moved toward each other and only the conductor at the angular positions where the base portions face one another is compressed.

In an example, the method comprises at least partially compressing the first part of the length of conductor prior to locating it around the first portion of the central axis, and around the second portion of the central axis.

In an example, the method comprises bonding adjacent turns of the plurality of turns of conductor to each other.

In an example, the first component comprises a ferrite material.

In an example, the second component comprises a ferrite material.

In an example, the conductor comprises a multi-strand wire.

In an example, the conductor comprises a Litz wire.

Thus, a new technology has been developed that in specific embodiments utilizes a deformable conductor formed for example from multi-stranded wire or Litz wire/coils and methods for gap distribution of the fringing field that provides for copper packing by compressing the conductor wire, including for example after it has been formed around the core area shape, and also avoiding the fringing field to achieve a high performance coil with low thermal heat generation and brilliant thermal transfer.

Specifically:
1) The compressed multi-stranded coil can be made to fill the window area to higher levels (above 80% copper fill), above that of flat wire or standard Litz bundles wound coils. The new inductor coil can be made from either multi stranded wire bundles or bundles with a very loose twist (Litz) and indeed other deformable wire. It is to be noted that if the wire is made with a twist, then the twist should be “loose” in order that deformation of the wire can occur to get optimum copper fill within the window area. Other technologies uses non compressed Litz wire which only achieves substandard copper fill, the other technique is to use type 8 Litz wire that is already compressed, this puts tension on the wire when winding around the pole area and again sub optimal copper fills are achievable.
2) Having control over the stand positioning and deformation allows for the copper to be manipulated into shapes that can be used to avoid the fringing field seen in gapped transformers and inductors. The copper can be compressed in such a way that the copper does not induce eddy current caused by conductive material being present in these fringing fields.

Specific embodiments are now described, where reference is again made to FIGS. 1-13.

FIG. 1 shows a cross-section through a detailed specific embodiment of an inductor coil. A first component part 12 of a ferrite material is shown at the top. This has a base portion, and a cylindrical core portion extending downwards. Outer limb portions extend downwards and are spaced from the core portion and within which turns of a conductor 18 in the form of a multi-strand wire can be located. A second component part 14 again of a ferrite material shown in the bottom. This again has a base portion, and a cylindrical core portion 16 extending upwards, and outer limb portions that extend upwards and spaced from the core portion and within which turns of the conductor 18 can be located. The core portions of the of the first component part of the second component part form a core 16. A centre 20 in the core is shown between the two component parts, with a centre gap has a dimension 24 that can for example be 1 mm, but can be greater than or less than this. Six turns of the multi-strand wire are shown would around the core and the gap in the core, but there can be less than or more than this. In addition to a gap 20 being provided between the cores, a gap 22 is formed around this central gap and the wire turns do not encroach into this gap 22, and as shown wire turns have been deformed to keep them out of this gap 22. Thus FIG. 1 illustrates that the cross section for each turn is kept the same, but under compression free space is created to avoid the gap created by the ferrite. The central gap 20 is the area in which non-conductive material spacer 30 can be placed that forms the gap 22, discussed in more detail below.

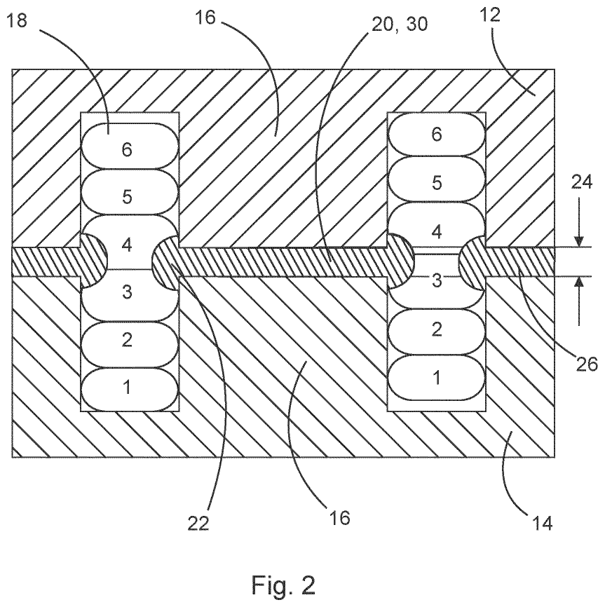

FIG. 2 shows a cross-section through a detailed specific embodiment of an inductor coil, that is similar to that shown in FIG. 1 except that the gap is distributed across a combination of limb portions, with the wire turns in the region of the central 22 being kept out of an inner 22 and also been kept out of an outer gap 28. Thus, in addition to a gap 20 in the core 16, there is also a gap 26 in the outer limb portions. Both of these gaps can be filled with spaces, that create the inner 22 and outer 28 gaps.

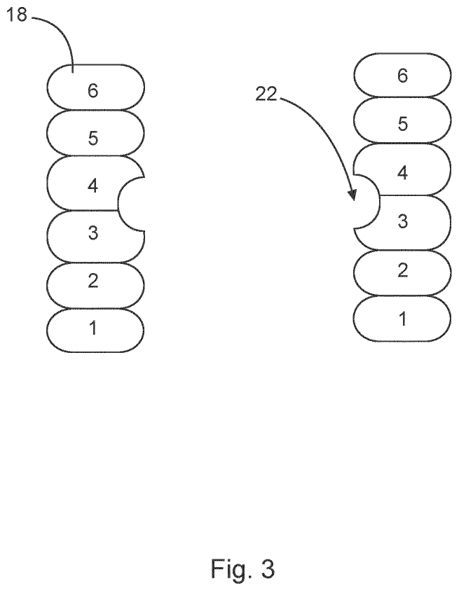

FIG. 3 shows a cross-section through the six wire turns of the embodiment of FIG. 1 and illustrates the wire turns of the coil after compression, showing the shape of the gap 22 that id formed that avoids the fringing field of a centre gapped core. This could be the same for an off centre gap or a distributed gap in several locations between the two core components. This shape can be retained further by using such multi-stranded or litz wire with self-bonding characteristics.

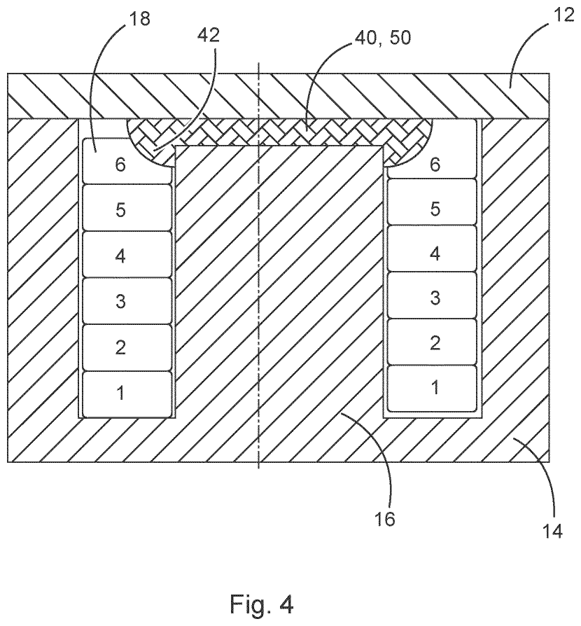

FIG. 4 shows a cross-section through a detailed specific embodiment of an inductor coil. A first component part 12 of a ferrite material is shown at the top. This has a base portion. A second component part 14 again of a ferrite material shown at the bottom. This again has a base portion, and has a cylindrical core 16 extending upwards. Outer limb portions extend upwards and are spaced from the core, within which turns of a conductor 18 in the form of a multi-strand wire can be located. The core 16 is spaced from the base portion of the first component part to form a gap 40 in the core. Six turns of the multi-strand wire or shown wound around the core and the gap in the core, but there can be less than or more than this. In addition to a gap 40 being provided between the core and the first component part, a gap 42 is formed effectively in the core between the core and the first component part, and the wire turns do not encroach into this gap 42, and as shown wire turns have been deformed to keep them out of this gap 42. Thus again FIG. 4 illustrates that the cross section for each turn is kept the same, but under compression free space is created to avoid the gap created by the ferrite. The top gap 40 is the area in which non-conductive material spacer 50 can be placed that forms the gap 42, discussed in more detail below.

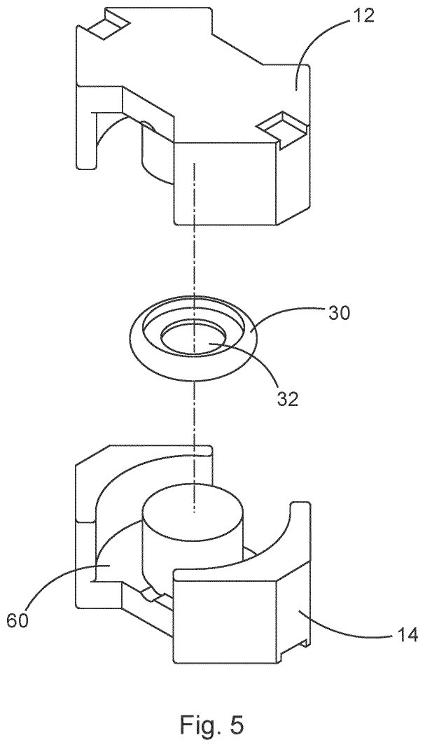

FIG. 5 shows a detailed specific embodiment of an inductor coil, for example as shown in FIG. 1 that has a central gap 20 in the core. The first component part 12 and the second component part 14 shown separated from one another, and the spacer 30 is shown that also has a central hole 32. As shown there was a space 60 in both the first and second component parts for windings of the conductor 18 in the form of a multi-strand wire. Thus this figure illustrates a non-conductive insert (spacer 30) that extends over the pole length. This can be used with and without the hole in the centre 32 of the non-conductive part. This can be added during the compression or after the compression of the wires to ensure that the wires do not enter the fringing field after compression.

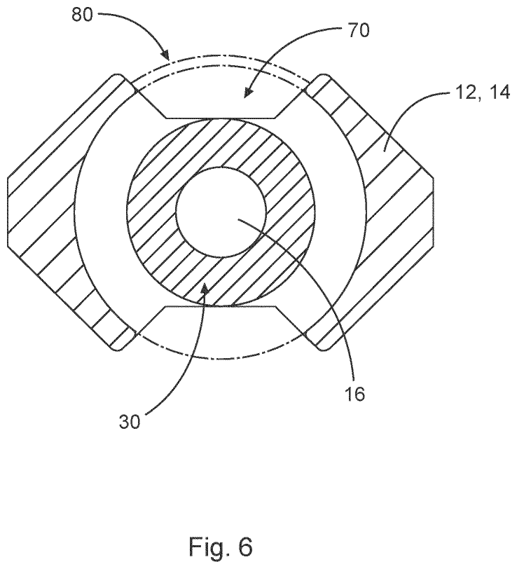

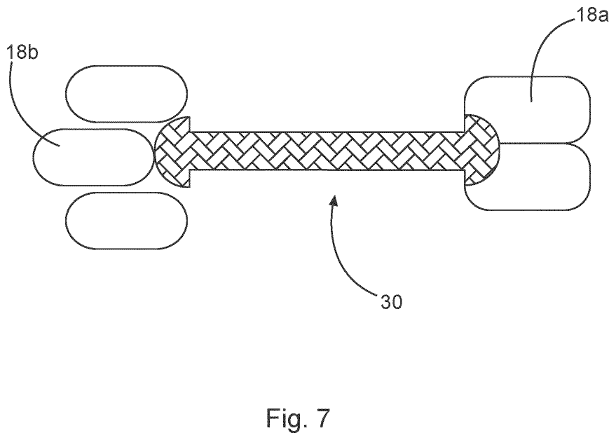

FIG. 6 shows a representative cross-section through an inductor coil, showing a through the outer limbs of a first component part 12 or a second component part 14, showing top surface of core 16 of one of the 2 component parts. With a cross-section through the centre of the gap spacer 30 the outer limbs of the first or second component part or actually also not actually been cut through but are the top surface. FIG. 7 shows a representation on the left of how the turns of the wire can be pushed sideways by the spacer 30, and shows a representation on the right of how the turns of the wire can be deformed by the spacer 30 in the region of central gap 20 to keep the turns of the wire conductor 18 out of the fringing field. The figures therefore illustrate how the ring spacer 30 can be used to either compress the conductive wire 18 or to allow the bundle or strand to jump over the space containing the fringing field, and illustrates of how the wire could form a bump 80 outside of the core shape where space 70 may be free for the wire to enter. Thus the spacer 30 by keeping the terms of the wire conductor out of the fringing field, produces heat production, improves thermal stability.

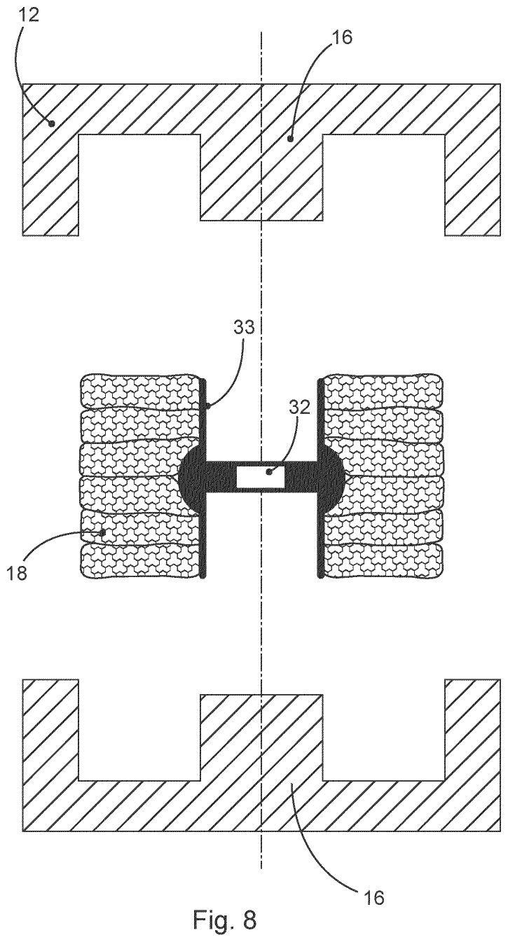

FIG. 8 shows a cross-section through a detailed specific embodiment of an inductor coil, for example as shown in FIG. 1. This shows that the wire conductor 18 in the form of a multi-strand wire can be partially compressed prior to it being located around the core 16 formed from the first component part 12 and the second component part 14. Here, the wire conductor 18 has been wound around a spacer 30 with a central hole 32, and that has a cylindrical sleeve 33. The wires have then been compressed, and the end portions of the spacer 30 are wider than the diameter of the cylindrical core 16, and therefore form spaces 22 around the spacer 30 where there is no wire. When the first component part and the second component part are brought together, the core portions slide within the wire turns and the depth of the already compressed wire turns is slightly deeper than their available space and therefore the wire is further compressed due to the mounting force, where for example the outer limbs of the first component part 12 and the second component part 14 can be brought together as shown in FIG. 1 but with the core portions not meeting to form the core 16 that has a gap 20. The sleeve 33 is not necessary and indeed the wires can be deformed to have a space 22 that will be located around the gap 20 in the core 16 without requiring the spacer 30.

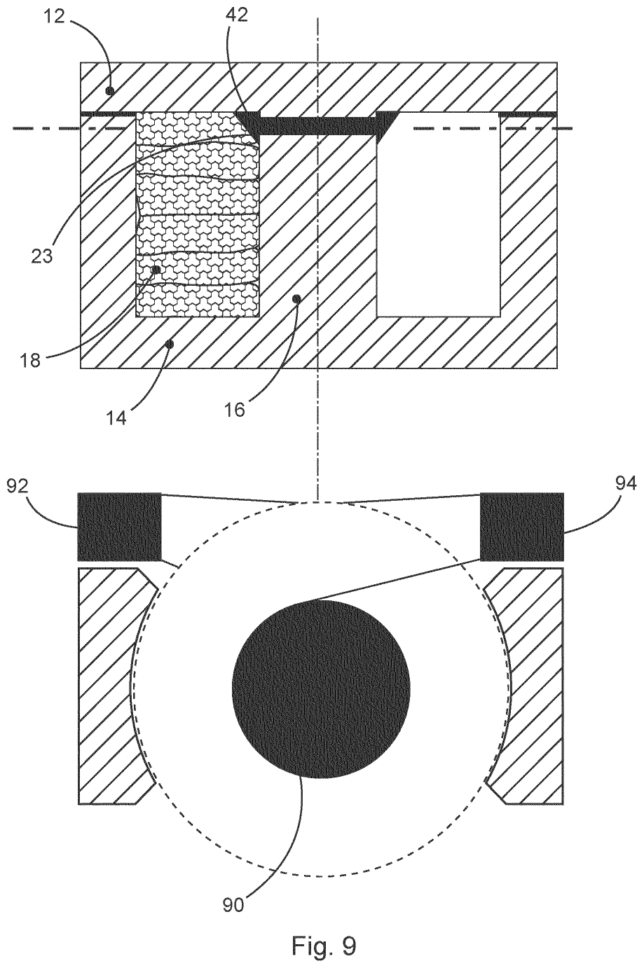

FIG. 9 shows at the top a cross-section through a detailed specific embodiment of an inductor coil, for example as shown in FIG. 4, at the bottom representation is shown of terminal connections to both ends of the conductor 18 in the form of a multi-strand wire. Thus a ferrite cage is provided, with a gap 40 in the core 16 provided at the top, where the spacer 50 is located to create a gap 42 around the gap in the core whether windings of the conductor do not encroach. In this embodiment, it can be easier to mount the spacer 50 than for a centrally mounted spacer 30. The spacer 50 can in effect be used as a push-up art in order to move the filaments or strands of the wire turns away, and to create the necessary defamation of at least one winding at the top. Thus, in this embodiment the copper windings can be transformed into a different geometry by pusher part which is working like a robust eddy current mitigation element. The view from the top, shows top 94 and bottom terminals 92 where for example the end of the windings can be prepared to be connected with power electronic boards, such as a PCB. Various mechanisms can be utilised to connect the end of the conductor wire is required, for example with a compressed coil terminal with a whole use for mechanical fixation pressed coil terminal disordered for example to a tin plated brass multi-terminal connector and then soldered to a PCB.

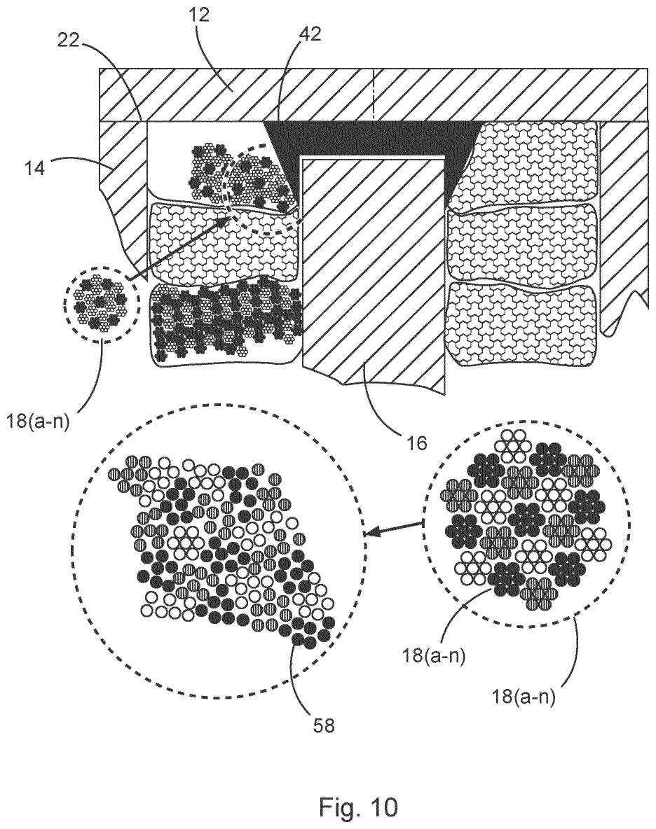

FIG. 10 shows a cross-section through a detailed specific embodiment of an inductor coil, for example as shown in FIG. 4. A spacer part has created a gap 42 around a gap between the core 16 of a second component part 14 and the first component part 12. The wire conductor 18 is located the core and has been deformed. The wire conductor 18 is in the form of a multi-strand wire with bundles of wire 18a-18n. The wire conductor 18 was in one embodiment compressed whilst the wound configuration, then placed around the core 16 and then further compressed when the first component part 12 is connected to the second component part 14 and the spacer 50 was pushed downwards deforming one or more turns of the conductor as it was pushed downwards, and indeed all of the turns of the conductor 18 can be further compressed as the first and second component parts are connected one to the other. FIG. 10 shows a representation of how a cross-section of the multi-strand wire can deform and maintain its overall cross-section, and therefore current carrying capability, in the new inductor coil, but provide that wire is moved away from the gap in the core providing the benefits as described above.

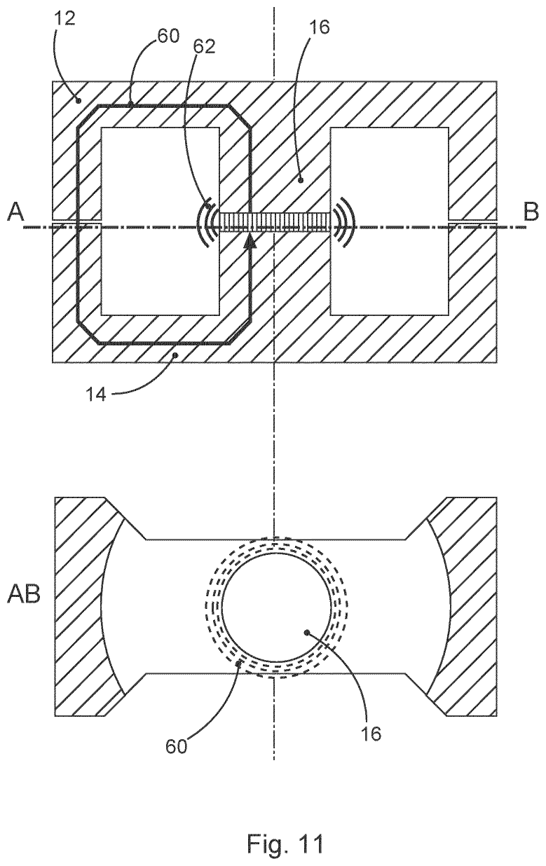

FIG. 11 shows a combination of the first part 12 and the second part 14 which form a magnetic flux cage, which is designed to carry a coil which is made from a length of the conductor 18. The magnetic field 60 penetrates the material of the first and the second part at least partially. In the surrounding space around the gap between the first and the second part there is a fringing field 62 which reaches into the space which is designed to carry a coil. The coil is not shown in FIG. 11. The fringing field 62 would create eddy losses as soon as the magnetic fringing field is alternating or changing. The losses increase as the frequency increases. The length of the conductor 18 (not shown) preferably comprises a multitude of partially parallel strands or fibers, forming a woven filament wire rope or a twisted wire or a litz wire. The benefit of the use of thin filaments is the reduced eddy current creation, which is smaller in case of thinner filaments. This new solution combines the use of electrically parallel filaments in each turn with the freedom of the space volume of the fringing field 62 which is not occupied by wires or filaments.

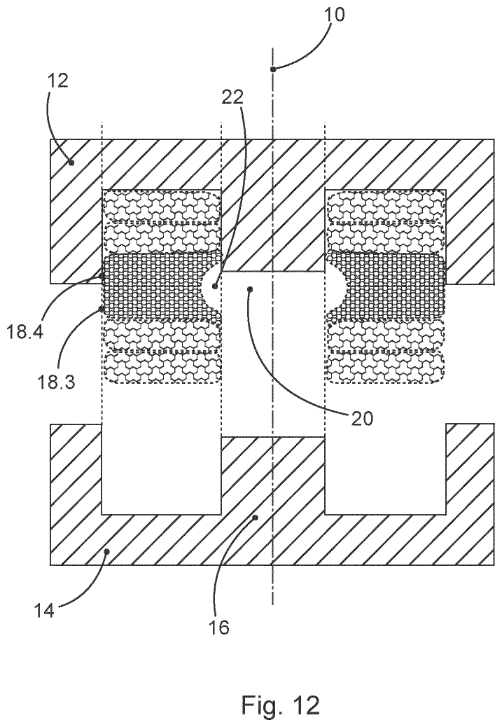

FIG. 12 shows an embodiment with two symmetrical parts 12 and 14 (they need not be symmetrical) which are forming a core 16 and a gap 20. FIG. 12 shows a coil made from a length of conductor 18 partially inserted into the first part 12 and the second part 14 that are still open. The cross-sectional shape of the windings of the length of conductor 18 comprise a cross-sectional shape deformation at least in turn 18.3 and 18.4 in the neighbourhood of the fringing field. The deformation is accompanied by a rearrangement of the group of electrically parallel filaments. A deformation of the single fibers may be present as well. The deformation of the fiber bundle, which is related to a turn of the winding of the conductor 18, is designed to create an open free space 22 around the gap 20 between part 12 and part 14. The free space 22 may be filled with a spacer, which is made from magnetically inert material in order to prevent wires and or fibers from penetrating or moving into that free space 22. However, the spacer is not essential as the wires and or fibers can be arranged not to penetrate or move into the free space 22, for example by having the wires or fibers bound one to the other, but the spacer provides a mechanism by which it is not possible for the wires or fibers to move into the “free space 22” occupied by the magnetically inert material of the spacer.

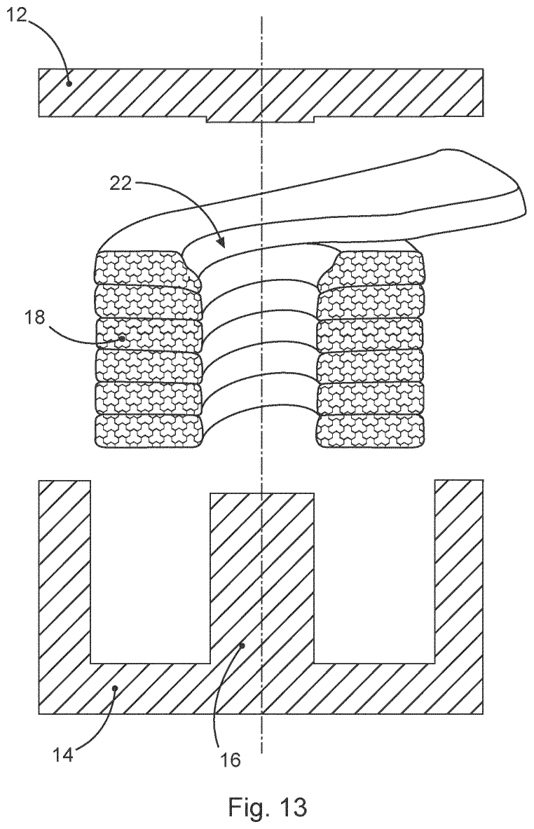

FIG. 13 shows a preformed coil comprising a pre-shaped length of conductor 18 prior to mounting this coil into the fee space inside of a magnetic flux cage. The magnetic flux cage comprises a top part 12 and a bottom part 14, which comprises a core 16 that is short enough to comprise a magnetic flux gap between top part 12 and bottom Part 14. The top part 12 may have a part of a recess to form a precise gap as shown in FIG. 13, or may be flat as well. The pre-shaped coil 18 comprises a deformation of at least the winding which is closest to the magnetic flux gap and the fringing field there. The conductor 18 preferably comprises electrically parallel wires or fibers and may be a litz wire or a stranded wire or a laminated conductor. The pre-shaped conductor 18 may be pre-compressed prior to the mounting and may show a relaxation after removal of the pre-compression means. The coil 18 may be re-compressed after fixing the top part 12 and the bottom part 14 in order to create a stable magnetic flux cage of the inductor. The re-compression may result in a compression of the conductor 18 in axial direction and a bit of expansion of the coil in the outer radius into radial direction of the coil. A mechanical contact may be existent between the outer surface of the coil 18 and the outer parts of the magnetic flux cage 12, 14 but a free space 22 is left free between the inner surface of the coil 18 and the gap area and around the gap area. Between the lower area of the core 16 and the inner surface of the coil a mechanical contact may be present. The mechanical contact between the coil and the magnetic flux cage 12, 14 may be used in order to conduct thermal energy from the conductor to the magnetic flux cage 12, 14.

### Additional Examples Relating to Pre-Shaping Technologies:

In an example the pre-shaped conductor 18, including the pre-shaped free space 22, is manufactured using a winding machine, which is controlling and shaping the cross sectional shape of the conductor 18 turn by turn in a design which results in a screw type arrangement of the windings along a central axis 10 of the coil. Such arrangements are shown in FIG. 12 and FIG. 13. The windings are pre-compressed in axial direction and bended in a screw-plane around the central axis.

In an example the windings of the coil are pre-shaped into a screw type arrangement around a central axis with a inner open diameter which is designed to fit into the open volume of the magnetic flux ring made from part 12 and 14. The screw type winding is then compressed at least partially in axial direction and the winding cross-section is expanded radially according to this compression. The total cross-sectional area of the windings can remain about the same through compression, thus the compression and the change of the cross-sectional shape is associated with a geometrical re-arrangement of the fibers of the thin wires or filaments of the conductor 18, which are forming the compressed part of the conductor

Thus, a new inductor coil is provided that has a gap in the core, either centrally between to ferrite components or next to one of the ferrite components, with a gap is either an air gap or has a nonconductive spacer. The gap can be important in inductor design, because it can be used with respect to the control of magnetic resistance in magnetic circuit. However, now eddy currents in the windings of the coil are prevented because the wire is kept away from this. Furthermore, copper density of the overall windings of the inductor coil increased due to deformation of the windings through compression, which can occur before and/or during the mounting process. When a nonconductive spacer is utilised, it helps to keep the conductor out of the eddy current space, acts like a pusher will to form a and keeps at least one winding in a deformed geometry, and indeed a counter twist can be provided that creates a partially more parallel (than twisted) multi-strand wire.

The following relates to examples, that provide specific details on a number of possible arrangements of the inductor coils, and specific details on a number of possible ways of forming the inductor coils
Example 1. An inductor coil, comprising:
   a first component 12;
   a second component 14; and
   a length of conductor 18;
   wherein, the first component is located adjacent to the second component;
   wherein, a core 16 is formed from the first component and the second component;
   wherein the core is located along a first portion of a central axis and a second portion of the central axis;
   wherein, along a third portion of the central axis the first component is spaced from the second component to form a gap 20, 30 in the core, wherein the third portion of the central axis is between the first portion of the central axis and the second portion of the central axis;
   wherein, a first part of the length of conductor is located around the first portion of the central axis, located around the second portion of the central axis, and located around the third portion of the central axis to form a plurality of turns of conductor around the core and the gap in the core; and
   wherein, at least one section of the first part of the length of conductor is compressed in the direction of the central axis.
Example 2. Inductor coil according to Example 1, wherein the at least one section of the first part of the length of conductor that is compressed has a dimension of the conductor in the direction of the central axis that is less than a dimension of the conductor in a direction perpendicular to the central axis.
Example 3. Inductor coil according to any of Examples 1-2, wherein at least one section of the first part of the length of conductor between a base portion of the first component and a base portion of the second component is compressed between and by the base portion of the first component and the base portion of the second component.
Example 4. Inductor coil according to any of Examples 1-3, wherein the first part of the length of conductor is at least partially compressed prior to being located around the first portion of the central axis, located around the second portion of the central axis, and located around the third portion of the central axis.
Example 5. Inductor coil according to any of Examples 1-4, wherein adjacent turns of the plurality of turns of conductor are bonded to each other.
Example 6. Inductor coil according to any of Examples 1-5, wherein each turn of conductor of the plurality of turns of conductor has an inner part of the conductor spaced at least one distance from the central axis in a direction perpendicular to the central axis, wherein the inner part of the conductor of two or more turns of the conductor located around the first portion of the central axis and/or located around the second portion of the central axis are spaced from the central axis by at least one first distance, and wherein the inner part of the conductor of one or more turns of the conductor located around the third portion of the central axis is spaced from the central axis by at least one second distance greater than the at least one first distance.
Example 7. Inductor coil according to any of Examples 1-6, wherein a spacer 30 is located in the gap in the core to form a gap 22 around the core, wherein an outer surface of a portion of the spacer is located a distance from the central axis that is greater than a distance from the central axis of an outer surface of the first component and an outer surface of the second component that form the core.
Example 8. Inductor coil according to Example 7, wherein a dimension of the portion of the spacer adjacent to the outer surface of the first component and the outer surface of the second component in the direction of the central axis is greater than a dimension of the gap 24 in the core in the direction of the central axis.
Example 9. Inductor coil according to any of Examples 7-8 when dependent upon Example 6, wherein the outer surface of the portion of the spacer is configured to contact the one or more turns of conductor located around the third portion of the central axis.
Example 10. Inductor coil according to any of Examples 7-9, wherein the spacer comprises a non-conductive material.
Example 11. Inductor coil according to any of Examples 7-10, wherein the spacer comprises a central hole 32 configured to be located around the central axis.
Example 12. Inductor coil according to any of Examples 1-11, wherein the first component comprises a ferrite material.
Example 13. Inductor material according to any of Examples 1-12, wherein the second component comprises a ferrite material.
Example 14. Inductor coil according to any of Examples 1-13, wherein the conductor comprises a multi-strand wire.
Example 15. Inductor coil according to any of Examples 1-14, wherein the conductor comprises a Litz wire.
Example 16. An inductor coil, comprising:
   a first component 12;
   a second component 14; and
   a length of conductor 18;
   wherein, the first component is located adjacent to the second component;
   wherein, a core 16 is formed from the second component;
   wherein the core is located along a first portion of a central axis;
   wherein, along a second portion of the central axis the first component is spaced from the second component to form a gap 40, 50 in the core, wherein the second portion of the central axis is between the first portion of the central axis and the first component;
   wherein, a first part of the length of conductor is located around the first portion of the central axis, and located around the second portion of the central axis to form a plurality of turns of conductor around the core and the gap in the core; and
   wherein, at least one section of the first part of the length of conductor is compressed in the direction of the central axis.
Example 17. Inductor coil according to Example 16, wherein the at least one section of the first part of the length of conductor that is compressed has a dimension of the conductor in the direction of the central axis that is less than a dimension of the conductor in a direction perpendicular to the central axis.
Example 18. Inductor coil according to any of Examples 16-17, wherein at least one section of the first part of the length of conductor between a base portion of the first component and a base portion of the second component is compressed between and by the base portion of the first component and the base portion of the second component.
Example 19. Inductor coil according to any of Examples 16-18, wherein the first part of the length of conductor is at least partially compressed prior to being located around the first portion of the central axis, and located around the second portion of the central axis.
Example 20. Inductor coil according to any of Examples 16-19, wherein adjacent turns of the plurality of turns of conductor are bonded to each other.
Example 21. Inductor coil according to any of Examples 16-20, wherein each turn of conductor of the plurality of turns of conductor has an inner part of the conductor spaced at least one distance from the central axis in a direction perpendicular to the central axis, wherein the inner part of the conductor of two or more turns of the conductor located around the first portion of the central axis are spaced from the central axis by at least one first distance, and wherein the inner part of the conductor of one or more turns of the conductor located around the second portion of the central axis is spaced from the central axis by at least one second distance greater than the at least one first distance.
Example 22. Inductor coil according to any of Examples 16-21, wherein a spacer 50 is located in the gap in the core to form a gap 42 around the core, wherein an outer surface of a portion of the spacer is located a distance from the central axis that is greater than a distance from the central axis of an outer surface of the second component that forms the core.
Example 23. Inductor coil according to Example 22, wherein a dimension of the portion of the spacer adjacent to the outer surface of the second component in the direction of the central axis is greater than a dimension of the gap 24 in the core in the direction of the central axis.
Example 24. Inductor coil according to any of Examples 22-23 when dependent upon Example 21, wherein the outer surface of the portion of the spacer is configured to contact the one or more turns of conductor located around the second portion of the central axis.
Example 25. Inductor coil according to any of Examples 22-24, wherein the spacer comprises a non-conductive material.
Example 26. Inductor coil according to any of Examples 22-25, wherein the spacer comprises a central hole configured to be located around the central axis.
Example 27. Inductor coil according to any of Examples 16-26, wherein the first component comprises a ferrite material.
Example 28. Inductor material according to any of Examples 16-27, wherein the second component comprises a ferrite material.
Example 29. Inductor coil according to any of Examples 16-28, wherein the conductor comprises a multi-strand wire.
Example 30. Inductor coil according to any of Examples 16-29, wherein the conductor comprises a Litz wire.
Example 31. An inductor coil, comprising:
   a first component 12;
   a second component 14; and
   a length of conductor 18;
   wherein, the first component is located adjacent to the second component;
   wherein, a core 16 is formed from the first component and the second component;
   wherein the core is located along a first portion of a central axis and a second portion of the central axis;
   wherein, along a third portion of the central axis the first component is spaced from the second component to form a gap 20, 30 in the core, wherein the third portion of the central axis is between the first portion of the central axis and the second portion of the central axis;
   wherein, a first part of the length of conductor is located around the first portion of the central axis, located around the second portion of the central axis, and located around the third portion of the central axis to form a plurality of turns of conductor around the core and the gap in the core; and
   wherein each turn of conductor of the plurality of turns of conductor has an inner part of the conductor spaced at least one distance from the central axis in a direction perpendicular to the central axis, wherein the inner part of the conductor of two or more turns of the conductor located around the first portion of the central axis and/or located around the second portion of the central axis are spaced from the central axis by at least one first distance, and wherein the inner part of the conductor of one or more turns of the conductor located around the third portion of the central axis is spaced from the central axis by at least one second distance greater than the at least one first distance.
Example 32. Inductor coil according to Example 31, wherein a spacer 30 is located in the gap in the core to form a gap 22 around the core, wherein an outer surface of a portion of the spacer is located a distance from the central axis that is greater than a distance from the central axis of an outer surface of the first component and an outer surface of the second component that form the core.
Example 33. Inductor coil according to Example 32, wherein a dimension of the portion of the spacer adjacent to the outer surface of the first component and the outer surface of the second component in the direction of the central axis is greater than a dimension of the gap 24 in the core in the direction of the central axis.
Example 34. Inductor coil according to any of Examples 32-33, wherein the outer surface of the portion of the spacer is configured to contact the one or more turns of conductor located around the third portion of the central axis.
Example 35. Inductor coil according to any of Examples 32-34, wherein the spacer comprises a non-conductive material.
Example 36. Inductor coil according to any of Examples 32-35, wherein the spacer comprises a central hole 32 configured to be located around the central axis.
Example 37. Inductor coil according to any of Examples 32-36, wherein at least one section of the first part of the length of conductor is compressed in the direction of the central axis.
Example 38. Inductor coil according to Example 37, wherein the at least one section of the first part of the length of conductor that is compressed has a dimension of the conductor in the direction of the central axis that is less than a dimension of the conductor in a direction perpendicular to the central axis.
Example 39. Inductor coil according to any of Examples 37-38, wherein at least one section of the first part of the length of conductor between a base portion of the first component and a base portion of the second component is compressed between and by the base portion of the first component and the base portion of the second component.
Example 40. Inductor coil according to any of Examples 31-39, wherein the first part of the length of conductor is at least partially compressed prior to being located around the first portion of the central axis, located around the second portion of the central axis, and located around the third portion of the central axis.
Example 41. Inductor coil according to any of Examples 31-40, wherein adjacent turns of the plurality of turns of conductor are bonded to each other.
Example 42. An inductor coil, comprising:
   a first component 12;
   a second component 14; and
   a length of conductor 18;
   wherein, the first component is located adjacent to the second component;
   wherein, a core 16 is formed from the second component;
   wherein the core is located along a first portion of a central axis;
   wherein, along a second portion of the central axis the first component is spaced from the second component to form a gap 40, 50 in the core, wherein the second portion of the central axis is between the first portion of the central axis and the first component;
   wherein, a first part of the length of conductor is located around the first portion of the central axis, and located around the second portion of the central axis to form a plurality of turns of conductor around the core and the gap in the core; and
   wherein each turn of conductor of the plurality of turns of conductor has an inner part of the conductor spaced at least one distance from the central axis in a direction perpendicular to the central axis, wherein the inner part of the conductor of two or more turns of the conductor located around the first portion of the central axis are spaced from the central axis by at least one first distance, and wherein the inner part of the conductor of one or more turns of the conductor located around the second portion of the central axis is spaced from the central axis by at least one second distance greater than the at least one first distance.
Example 43. Inductor coil according to Example 42, wherein a spacer 50 is located in the gap in the core to form a gap 42 around the core, wherein an outer surface of a portion of the spacer is located a distance from the central axis that is greater than a distance from the central axis of an outer surface of the second component that forms the core.
Example 44. Inductor coil according to Example 43, wherein a dimension of the portion of the spacer adjacent to the outer surface of the second component in the direction of the central axis is greater than a dimension of the gap 24 in the core in the direction of the central axis.
Example 45. Inductor coil according to any of Examples 43-44, wherein the outer surface of the portion of the spacer is configured to contact the one or more turns of conductor located around the second portion of the central axis.
Example 46. Inductor coil according to any of Examples 43-45, wherein the spacer comprises a non-conductive material.
Example 47. Inductor coil according to any of claims 43-46, wherein the spacer comprises a central hole configured to be located around the central axis.
Example 48. Inductor coil according to any of Examples 42-47, wherein at least one section of the first part of the length of conductor is compressed in the direction of the central axis.
Example 49. Inductor coil according to Example 48, wherein the at least one section of the first part of the length of conductor that is compressed has a dimension of the conductor in the direction of the central axis that is less than a dimension of the conductor in a direction perpendicular to the central axis.
Example 50. Inductor coil according to any of Examples 42-49, wherein at least one section of the first part of the length of conductor between a base portion of the first component and a base portion of the second component is compressed between and by the base portion of the first component and the base portion of the second component.
Example 51. Inductor coil according to any of Examples 42-50, wherein the first part of the length of conductor is at least partially compressed prior to being located around the first portion of the central axis, and located around the second portion of the central axis.
Example 52. Inductor coil according to any of Examples 42-51, wherein adjacent turns of the plurality of turns of conductor are bonded to each other.
Example 53. Inductor coil according to any of Examples 42-52, wherein the first component comprises a ferrite material.
Example 54. Inductor material according to any of Examples 42-53, wherein the second component comprises a ferrite material.
Example 55. Inductor coil according to any of Examples 42-54, wherein the conductor comprises a multi-strand wire.
Example 56. Inductor coil according to any of Examples 42-55, wherein the conductor comprises a Litz wire.
Example 57. A method of forming an inductor coil, comprising:
   locating a first component 12 adjacent to a second component 14, wherein, a core 16 is formed from the first component and the second component, wherein the core is located along a first portion of a central axis and a second portion of the central axis, and wherein along a third portion of the central axis the first component is spaced from the second component to form a gap 20, 30 in the core, wherein the third portion of the central axis is between the first portion of the central axis and the second portion of the central axis;
   locating a first part of a length of conductor 18 around the first portion of the central axis, around the second portion of the central axis, and around the third portion of the central axis to form a plurality of turns of conductor around the core and the gap in the core; and
   compressing in the direction of the central axis at least one section of the first part of the length of conductor.
Example 58. Method according to Example 57, wherein the at least one section of the first part of the length of conductor that is compressed has a dimension of the conductor in the direction of the central axis that is less than a dimension of the conductor in a direction perpendicular to the central axis.
Example 59. Method according to any of Examples 57-58, wherein the method comprises compressing at least one section of the first part of the length of conductor between a base portion of the first component and a base portion of the second component.
Example 60. Method according to any of Examples 57-59, wherein the method comprises at least partially compressing the first part of the length of conductor prior to locating it around the first portion of the central axis, around the second portion of the central axis, and around the third portion of the central axis.
Example 61. Method according to any of Examples 57-60, wherein the method comprises bonding adjacent turns of the plurality of turns of conductor to each other.
Example 62. Method according to any of Examples 57-61, the method comprises locating the length of conductor such that each turn of conductor of the plurality of turns of conductor has an inner part of the conductor spaced at least one distance from the central axis in a direction perpendicular to the central axis, wherein the inner part of the conductor of two or more turns of the conductor located around the first portion of the central axis and/or located around the second portion of the central axis are spaced from the central axis by at least one first distance, and wherein the inner part of the conductor of one or more turns of the conductor located around the third portion of the central axis is spaced from the central axis by at least one second distance greater than the at least one first distance.
Example 63. Method according to any of Examples 57-62, wherein the method comprises locating a spacer 30 in the gap in the core to form a gap 22 around the core, wherein an outer surface of a portion of the spacer is located a distance from the central axis that is greater than a distance from the central axis of an outer surface of the first component and an outer surface of the second component that form the core.
Example 64. Method according to Example 63, wherein a dimension of the portion of the spacer adjacent to the outer surface of the first component and the outer surface of the second component in the direction of the central axis is greater than a dimension of the gap 24 in the core in the direction of the central axis.
Example 65. Method according to any of Examples 63-64 when dependent upon Example 62, wherein the method comprises contacting the outer surface of the portion of the spacer with the one or more turns of conductor located around the third portion of the central axis.
Example 66. Method according to any of Examples 63-65, wherein the spacer comprises a non-conductive material.
Example 67. Method according to any of Examples 63-66, wherein the spacer comprises a central hole 32 configured to be located around the central axis.
Example 68. Method according to any of Examples 57-67, wherein the first component comprises a ferrite material.
Example 69. Method according to any of Examples 57-68, wherein the second component comprises a ferrite material.
Example 70. Method according to any of Examples 57-69, wherein the conductor comprises a multi-strand wire.
Example 71. Method according to any of Examples 57-69, wherein the conductor comprises a Litz wire.
Example 72. A method of forming an inductor coil, comprising:
   locating a first component 12 adjacent to a second component 14, wherein a core is formed from the second component, wherein the core is located along a first portion of a central axis, wherein along a second portion of the central axis the first component is spaced from the second component to form a gap 40, 50 in the core, and wherein the second portion of the central axis is between the first portion of the central axis and the first component;
   locating a first part of a length of conductor 18 around the first portion of the central axis, and around the second portion of the central axis to form a plurality of turns of conductor around the core and the gap in the core; and
   compressing in the direction of the central axis at least one section of the first part of the length of conductor.
Example 73. Method according to Example 72, wherein the at least one of the first part of the length of conductor that is compressed has a dimension of the conductor in the direction of the central axis that is less than a dimension of the conductor in a direction perpendicular to the central axis.
Example 74. Method according to any of Examples 72-73, wherein method comprises compressing at least one section of the first part of the length of conductor between a base portion of the first component and a base portion of the second component.
Example 75. Method according to any of Examples 72-74, wherein the method comprises at least partially compressing the first part of the length of conductor prior to locating it around the first portion of the central axis, and around the second portion of the central axis.
Example 76. Method according to any of Examples 72-75, wherein the method comprises bonding adjacent turns of the plurality of turns of conductor to each other.
Example 77. Method according to any of Examples 72-76, wherein the method comprises locating the length of conductor such that each turn of conductor of the plurality of turns of conductor has an inner part of the conductor spaced at least one distance from the central axis in a direction perpendicular to the central axis, wherein the inner part of the conductor of two or more turns of the conductor located around the first portion of the central axis are spaced from the central axis by at least one first distance, and wherein the inner part of the conductor of one or more turns of the conductor located around the second portion of the central axis is spaced from the central axis by at least one second distance greater than the at least one first distance.
Example 78. Method according to any of Examples 72-7, wherein the method comprises locating a spacer 50 in the gap in the core to form a gap 42 around the core, wherein an outer surface of a portion of the spacer is located a distance from the central axis that is greater than a distance from the central axis of an outer surface of the second component that forms the core.
Example 79. Method according to Example 78, wherein a dimension of the portion of the spacer adjacent to the outer surface of the second component in the direction of the central axis is greater than a dimension of the gap 24 in the core in the direction of the central axis.
Example 80. Method according to any of Examples 78-79 when dependent upon Example 7, wherein the method comprises contacting the outer surface of the portion of the spacer with the one or more turns of conductor located around the second portion of the central axis.
Example 81. Method according to any of Examples 72-80, wherein the spacer comprises a non-conductive material.
Example 82. Method according to any of Examples 72-81, wherein the spacer comprises a central hole configured to be located around the central axis.
Example 83. Method according to any of Examples 72-82, wherein the first component comprises a ferrite material.
Example 84. Method according to any of Examples 72-83, wherein the second component comprises a ferrite material.
Example 85. Method according to any of Examples 72-84, wherein the conductor comprises a multi-strand wire.
Example 86. Method according to any of Examples 72-85, wherein the conductor comprises a Litz wire.
Example 87. A method of forming an inductor coil, comprising:
   locating a first component 12 adjacent to the second component 14, wherein a core 16 is formed from the first component and the second component, wherein the core is located along a first portion of a central axis and a second portion of the central axis, wherein along a third portion of the central axis the first component is spaced from the second component to form a gap 20, 30 in the core, and wherein the third portion of the central axis is between the first portion of the central axis and the second portion of the central axis;
   locating a first part of the length of conductor 18 around the first portion of the central axis, around the second portion of the central axis, and around the third portion of the central axis to form a plurality of turns of conductor around the core and the gap in the core; and
   locating the first part of the length of conductor such that each turn of conductor of the plurality of turns of conductor has an inner part of the conductor spaced at least one distance from the central axis in a direction perpendicular to the central axis, wherein the inner part of the conductor of two or more turns of the conductor located around the first portion of the central axis and/or located around the second portion of the central axis are spaced from the central axis by at least one first distance, and wherein the inner part of the conductor of one or more turns of the conductor located around the third portion of the central axis is spaced from the central axis by at least one second distance greater than the at least one first distance.
Example 88. Method according to Example 87, wherein the method comprises locating a spacer 30 in the gap in the core to form a gap 22 around the core, wherein an outer surface of a portion of the spacer is located a distance from the central axis that is greater than a distance from the central axis of an outer surface of the first component and an outer surface of the second component that form the core.
Example 89. Method according to Example 88, wherein a dimension of the portion of the spacer adjacent to the outer surface of the first component and the outer surface of the second component in the direction of the central axis is greater than a dimension of the gap 24 in the core in the direction of the central axis.
Example 90. Method according to any of Examples 88-89, wherein the method comprises contacting the outer surface of the portion of the spacer with the one or more turns of conductor located around the third portion of the central axis.
Example 91. Method according to any of Examples 88-90, wherein the spacer comprises a non-conductive material.
Example 92. Method according to any of Examples 88-91, wherein the spacer comprises a central hole 32 configured to be located around the central axis.
Example 93. Method according to any of Examples 87-92, wherein the method comprises compressing at least one section of the first part of the length of conductor in the direction of the central axis.
Example 94. Method according to Example 93, wherein the at least one of the first part of the length of conductor that is compressed has a dimension of the conductor in the direction of the central axis that is less than a dimension of the conductor in a direction perpendicular to the central axis.
Example 95. Method according to any of Examples 87-94, wherein the method comprises compressing at least one section of the first part of the length of conductor between a base portion of the first component and a base portion of the second component.
Example 96. Method according to any of Examples 87-95, wherein the method comprises at least partially compressing the first part of the length of conductor prior to locating it around the first portion of the central axis, around the second portion of the central axis, and around the third portion of the central axis.
Example 97. Method according to any of Examples 87-96, wherein adjacent turns of the plurality of turns of conductor are bonded to each other.
Example 98. A method of forming an inductor coil, comprising:
   locating a first component 12 adjacent to a second component 14, wherein a core 16 is formed from the second component, wherein the core is located along a first portion of a central axis, wherein along a second portion of the central axis the first component is spaced from the second component to form a gap 40, 50 in the core, and wherein the second portion of the central axis is between the first portion of the central axis and the first component;
   locating a first part of a length of conductor 18 around the first portion of the central axis, and around the second portion of the central axis to form a plurality of turns of conductor around the core and the gap in the core; and
   locating the first part of the length of conductor such that each turn of conductor of the plurality of turns of conductor has an inner part of the conductor spaced at least one distance from the central axis in a direction perpendicular to the central axis, wherein the inner part of the conductor of two or more turns of the conductor located around the first portion of the central axis are spaced from the central axis by at least one first distance, and wherein the inner part of the conductor of one or more turns of the conductor located around the second portion of the central axis is spaced from the central axis by at least one second distance greater than the at least one first distance.
Example 99. Method according to Example 98, wherein the method comprises locating a spacer 50 in the gap in the core to form a gap 42 around the core, wherein an outer surface of a portion of the spacer is located a distance from the central axis that is greater than a distance from the central axis of an outer surface of the second component that forms the core.
Example 100. Method according to Example 99, wherein a dimension of the portion of the spacer adjacent to the outer surface of the second component in the direction of the central axis is greater than a dimension of the gap 24 in the core in the direction of the central axis.
Example 101. Method according to any of Examples 99-100, wherein the method comprises contacting the outer surface of the portion of the spacer with the one or more turns of conductor located around the second portion of the central axis.
Example 102. Method according to any of Examples 99-101, wherein the spacer comprises a non-conductive material.
Example 103. Method according to any of Examples 99-102, wherein the spacer comprises a central hole configured to be located around the central axis.
Example 104. Method according to any of Examples 98-103, wherein the method comprises compressing at least one section of the first part of the length of conductor in the direction of the central axis.
Example 105. Method according to Example 104, wherein the at least one section of the first part of the length of conductor that is compressed has a dimension of the conductor in the direction of the central axis that is less than a dimension of the conductor in a direction perpendicular to the central axis.
Example 106. Method according to any of Examples 98-105, wherein the method comprises compressing at least one section of the first part of the length of conductor between a base portion of the first component and a base portion of the second component.
Example 107. Method according to any of Examples 98-105, wherein the method comprises at least partially compressing the first part of the length of conductor prior to locating it around the first portion of the central axis, and around the second portion of the central axis.
Example 108. Method according to any of Examples 98-107, wherein the method comprises bonding adjacent turns of the plurality of turns of conductor to each other.
Example 109. Method according to any of Examples 98-108, wherein the first component comprises a ferrite material.
Example 110. Method according to any of Examples 98-109, wherein the second component comprises a ferrite material.
Example 111. Method according to any of Examples 98-110, wherein the conductor comprises a multi-strand wire.
Example 112. Method according to any of Examples 98-111, wherein the conductor comprises a Litz wire.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfill the functions of several items re-cited in the claims. The mere fact that certain measures are re-cited in mutually different dependent claims does not indicate that a combination of these measures cannot be used to advantage. Any reference signs in the claims should not be construed as limiting the scope.

What is claimed is:

1. An inductor coil, comprising:
a first component;
a second component;
a length of conductor;
a heat sink;
wherein, the first component is located adjacent to the second component;
wherein, a core is formed from the first component and the second component;
wherein, a first part of the length of conductor is wound around at least the core to form a plurality of turns of conductor;
wherein, the heat sink comprises a thermally conductive material;
wherein, the heat sink comprises a first part and a second part;
wherein, the first part of the heat sink has a first material and/or structural characteristic and the second part of the heat sink has a second material or structural characteristic different to the first material or structural characteristic; and
wherein, an inner surface of the first part of the heat sink is in contact with an outer surface of a part of the plurality of turns of conductor.

2. The inductor coil according to claim 1, wherein the first material or structural characteristic comprises a magnetic permeability and the second material or structural characteristic comprises a magnetic permeability greater than the magnetic permeability of the first part of the heat sink.

3. The inductor coil according to claim 1, wherein the first material or structural characteristic comprises a resistance or resistivity and the second material or structural characteristic comprises a resistance or resistivity less than the resistance or resistivity of the first part of the heat sink.

4. The inductor coil according to claim 3, wherein a circumferential resistance of the first part of the heat sink is greater than a radial resistance of the first part of the heat sink, and wherein the circumferential resistance of the first part of the heat sink is greater than a radial resistance of the second part of the heat sink and is greater than a circumferential resistance of the second part of the heat sink.

5. The inductor coil according to claim 1, wherein the first material or structural characteristic comprises a conductivity or conductance and the second material or structural characteristic comprises a conductivity or conductance less than the resistance or resistivity of the first part of the heat sink.

6. The inductor coil according to claim 5, wherein a circumferential conductance of the first part of the heat sink is less than a radial conductance of the first part of the heat sink, and wherein the circumferential conductance of the first part of the heat sink is less than a radial conductance of the second part of the heat sink and is less than a circumferential conductance of the second part of the heat sink.

7. The inductor coil according to claim 1, wherein the heat sink is formed from a single piece, wherein the first structural characteristic of the first part is different to the second structural characteristic of the second part.

8. The inductor coil according to claim 1, wherein the first part of the heat sink has a thickness in an axial direction of the core that is less than a thickness of the second part of the heat sink in the axial direction of the core.

9. The inductor coil according to claim 1, wherein, the first part of the heat sink comprises a plurality of slots or grooves.

10. The inductor coil according to claim 9, wherein the plurality of slots or grooves extend to the inner surface of the first part of the heat sink.

11. The inductor coil according to claim 9, wherein the plurality of slots or grooves extend to a boundary between the first part of the heat sink and the second part of the heat sink.

12. The inductor coil according to claim 9, wherein the plurality of slots or grooves each have a longitudinal axis that intersects with a central axis of the core.

13. The inductor coil according to claim 1, wherein the second part of the heat sink is configured to connect to a printed circuit board.

14. The inductor coil according to claim 1, wherein the heat sink comprises at least one third part located on at opposite side of the second part of the heat sink to the first part of the heat sink, and wherein the at least one third part of the heat sink is configured to transfer heat away from the second part of the heat sink.

15. The inductor coil according to claim 14, wherein a third part of the at least one third part the heat sink comprises a finned structured.

16. The inductor coil according to claim 14, wherein a third part of the at least one third part the heat sink comprises a connection terminal.

17. The inductor coil according to claim 16, wherein the connection terminal comprises the finned structure.

18. The inductor coil according to claim 16, wherein the connection terminal comprises a thick copper wire.

19. The inductor coil according to claim 1, wherein the second part of the heat sink comprises one or more pins configured for mechanical alignment with a printed circuit board or for mechanical fixation to the printed circuit board.

20. The inductor coil according to claim 1, wherein the first part and second part of the heat sink extend substantially in a direction perpendicular to a central axis of the core.

21. The inductor coil according to claim 1, wherein a core portion of the first component is spaced from a core portion of the second component to form a gap in the core; wherein the first part of the length of conductor is wound around the core and the gap in the core; wherein an inner part of the conductor of two or more turns of the conductor located around the core are spaced from a central axis of the core by at least one first distance; and wherein an inner part of the conductor of one or more turns of the conductor located around the gap in the core is spaced from the central axis by at least one second distance greater than the at least one first distance.

22. The inductor coil according to claim 1, wherein a core portion of the first component is spaced from a core portion of the second component to form a gap in the core; wherein a spacer is located in the gap in the core to form a gap around the core, wherein an outer surface of a portion of the spacer is located a distance from a central axis of the core that is greater than a distance from the central axis to an outer surface of the first component and an outer surface of the second component that form the core.

23. An inductor coil, comprising:
a first component;
a second component;
a length of conductor;
a heat sink;
wherein, the first component is located adjacent to the second component;
wherein, a core is formed from the second component;
wherein, a first part of the length of conductor is wound around at least the core to form a plurality of turns of conductor;
wherein, the heat sink comprises a thermally conductive material;
wherein, the heat sink comprises a first part and a second part;
wherein, the first part of the heat sink has a first material or structural characteristic and the second part of the heat sink has a second material or structural characteristic different to the first material or structural characteristic; and
wherein, an inner surface of the first part of the heat sink is in contact with an outer surface of a part of the plurality of turns of conductor.

24. A method of cooling an inductor coil, wherein the inductor coil comprises a first component, a second component, a length of conductor, wherein the first component is located adjacent to the second component, wherein a core is formed from the first component and the second component, wherein a first part of the length of conductor is wound around at least the core to form a plurality of turns of conductor, and wherein the method comprises:
utilizing a heat sink, wherein the heat sink comprises a thermally conductive material, wherein the heat sink comprises a first part and a second part, wherein, the first part of the heat sink has a first material or structural characteristic and the second part of the heat sink has a second material or structural characteristic different to the first material and/or structural characteristic; and
wherein, utilizing the heat sink comprises contacting an inner surface of the first part of the heat sink with an outer surface of a part of the plurality of turns of conductor.

25. A method of cooling an inductor coil, wherein the inductor coil comprises a first component, a second component, a length of conductor, wherein the first component is located adjacent to the second component, wherein a core is formed from the second component, wherein a first part of the length of conductor is wound around at least the core to form a plurality of turns of conductor, and wherein the method comprises:
utilizing a heat sink, wherein the heat sink comprises a thermally conductive material, wherein the heat sink comprises a first part and a second part, wherein, the first part of the heat sink has a first material or structural characteristic and the second part of the heat sink has a second material or structural characteristic different to the first material and/or structural characteristic; and
wherein utilizing the heat sink comprises contacting an inner surface of the first part of the heat sink with an outer surface of a part of the plurality of turns of conductor.
